(19) United States
(12) Patent Application Publication
(10) Pub. No.: US 2014/0072277 A1
(43) Pub. Date: Mar. 13, 2014

(54) ELECTRONIC DEVICE, CALENDAR INFORMATION PROCESSING METHOD, PROGRAM, AND INFORMATION RECORDING MEDIUM

(71) Applicant: Kabushiki Kaisha Toshiba, Tokyo (JP)

(72) Inventors: Yuji TAKAO, Hino-shi (JP); Tomomi NISHIGUCHI, Ome-shi (JP); Mieko ASANO, Kawasaki-shi (JP); Hideki OHKITA, Kunitachi-shi (JP); Atsushi NAKAJIMA, Higashimurayama-shi (JP)

(73) Assignee: Kabushiki Kaisha Toshiba, Tokyo (JP)

(21) Appl. No.: 14/015,596

(22) Filed: Aug. 30, 2013

Related U.S. Application Data
(63) Continuation of application No. PCT/JP2013/059423, filed on Mar. 22, 2013.

(30) Foreign Application Priority Data
Sep. 7, 2012 (JP) 2012-197328

(51) Int. Cl. H04N 7/025

(52) U.S. Cl. CPC H04N 7/0255
USPC 386/239; 348/564

(57) ABSTRACT

According to one embodiment, an acquisition module acquires additional information to be related to a calendar. A processing module creates an information calendar obtained by correlating the additional information with a calendar. A display controller outputs the information calendar to display the information calendar. An operation instruction module gives an instruction to operate based on the additional information of the information calendar.

### CROSS REFERENCE TO RELATED APPLICATIONS

This application is a Continuation application of PCT Application No. PCT/JP2013/059423, filed Mar. 22, 2013 and based upon and claiming the benefit of priority from Japanese Patent Application No. 2012-197328, filed Sep. 7, 2012, the entire contents of all of which are incorporated herein by reference.

### FIELD

Embodiments described herein relate generally to an electronic device, a calendar information processing method, a program, and an information recording medium.

### BACKGROUND

In recent years, the Internet service business has grown actively. In the Internet service business, information is exchanged in a communication environment between a server on the Internet and a personal computer and/or a mobile terminal (for example, a cell-phone, a tablet, or a personal digital assistant (PDA)).

A home digital television apparatus (hereinafter, referred to as a TV apparatus) has the advantage that the monitor screen is larger and clearer than that of another apparatus that can display a screen (for example, a personal computer, a cell-phone, or a tablet). In addition, the home TV apparatus further has the advantage that it can be equipped with a sophisticated audio system. A recent TV apparatus enables an Internet connection and a wide application of the TV apparatus connected to the Internet has been desired. At present, however, there is an opinion that the utilization of such a TV apparatus is insufficient. On the other hand, a small personal computer, a cell-phone, a tablet, or the like has the advantage of portability.

In addition, the TV apparatus can record a large number of programs. With such a tremendous amount of information, various methods of using the TV apparatus to process or organize information can be expected.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 shows an example of a menu screen displayed on a screen of a display module of a television apparatus according to an embodiment;

FIG. 2 shows another example of the menu screen displayed on the screen of the display module of the television apparatus according to the embodiment;

FIG. 3 shows still another example of the menu screen displayed on the screen of the display module of the television apparatus according to the embodiment;

FIG. 4 shows still another example of the menu screen displayed on the screen of the display module of the television apparatus according to the embodiment;

FIG. 5 shows a state where an electronic device of the embodiment has been incorporated in a digital television receiver;

FIG. 6 is a block diagram selectively showing a characteristic configuration of a cloud application module 231 in FIG. 5;

FIG. 7 shows the relationship between a TV apparatus 300 and a time cloud service server 411 when a scene information function is used in the embodiment;

FIG. 8 shows the relationship between the TV apparatus 300 and the time cloud service server 411 when a scene list function is used in the embodiment;

FIG. 9 shows the relationship between the TV apparatus 300 and the time cloud service server 411 when a scene play function is used in the embodiment;

FIG. 10 shows an example of servers included in the time cloud service server 411 in the embodiment;

FIG. 11 shows an example of components in a metadata server of FIG. 9 in the embodiment;

FIG. 12 shows a configuration of an electronic device of the embodiment and various functional modules of a DTV;

FIG. 13A shows an example of a page-a-month calendar displayed on TV apparatus of the embodiment;

FIG. 13B shows an example of an event list, additional information on a calendar, displayed on the TV apparatus of the embodiment;

FIG. 13C shows an example of an event list of FIG. 13B displayed in more detail on the TV apparatus of the embodiment;

FIG. 14A shows an example where Bob has logged on and Home of the time cloud service has been displayed on the TV apparatus of the embodiment;

FIG. 14B shows an example of a page-a-month calendar displayed on TV apparatus of the embodiment;

FIG. 14C shows an example of an event list displayed on the TV apparatus of the embodiment;

FIG. 14D shows an example of the details of recording reservation displayed on TV apparatus of the embodiment;

FIG. 15A shows an example of an event list scrolled on the TV apparatus of the embodiment;

FIG. 15B shows another example of an event list scrolled on the TV apparatus of the embodiment;

FIG. 15C shows still another example of an event list scrolled on the TV apparatus of the embodiment;

FIG. 15D shows still another example of an event list scrolled on the TV apparatus of the embodiment;

FIG. 15E shows still another example of an event list scrolled on the TV apparatus of the embodiment;

FIG. 15F shows another example of an event list scrolled on the TV apparatus of the embodiment;

FIG. 16A shows an example of a list displayed on the TV apparatus of the embodiment when a day with no plan has been selected from a page-a-month calendar;

FIG. 16B shows an example of an image displayed on the TV apparatus of the embodiment when the image has returned from the image of FIG. 16A;

FIG. 17A shows an example of an image of the transition of a page-a-month calendar on the TV apparatus of the embodiment;

FIG. 17B shows an example of an image of the transition of a page-a-month calendar on the TV apparatus of the embodiment;

FIG. 18A shows an example of an image of the transition of a page-a-month calendar on the TV apparatus of the embodiment;

FIG. 18B shows an example of an image of the transition of a page-a-month calendar on the TV apparatus of the embodiment;

FIG. 19A shows an example of an image of the transition of a page-a-month calendar on the TV apparatus of the embodiment;

FIG. 19B shows an example of an image of the transition of a page-a-month calendar on the TV apparatus of the embodiment;

FIG. 20A shows an example of icons displayed in a calendar on the TV apparatus of the embodiment;

FIG. 20B shows an example of icons displayed in a calendar on the TV apparatus of the embodiment;

FIG. 21 shows an example of an image when recording reservation information on another person is taken into the user's own calendar in the TV apparatus of the embodiment;

FIG. 22 shows an example of an image when recording reservation information on another person is taken into the user's own calendar in the TV apparatus of the embodiment;

FIG. 23 shows an example of an image when viewing reservation is cancelled in the TV apparatus of the embodiment;

FIG. 24 shows an example of an image when viewing reservation or recording reservation is taken into the user's own calendar in the TV apparatus of the embodiment;

FIG. 25 selectively shows a calendar information processing block in the TV apparatus of the embodiment;

FIG. 26 shows an example of an image when an event filtering function is executed in the TV apparatus of the embodiment;

FIG. 27 shows an example of a setting image for asking a friend for SynchroViewing in the TV apparatus of the embodiment;

FIG. 28 shows an example of a setting image for asking a friend for SynchroViewing in the TV apparatus of the embodiment;

FIG. 29 shows an example of an image of a page-a-month calendar displayed on the screen of a tablet in a system of the embodiment;

FIG. 30 shows an example of an image of a page-a-week calendar displayed on the screen of a tablet in the system of the embodiment;

FIG. 31 shows an example of an image of a page-a-day calendar displayed on the screen of a tablet in the system of the embodiment; and

FIG. 32 shows another example of the details of an event, additional information on a calendar, displayed on the system of the embodiment.

### DETAILED DESCRIPTION

Various embodiments will be described hereinafter with reference to the accompanying drawings.

In general, according to one embodiment, there are provided an electronic device, a calendar information processing method, a program, and information recording medium which are capable of improving not only the function of informing the user but also the usability.

According to an embodiment of the present disclosure, an electronic device includes a storage module which stores first additional information related to a first calendar, an information acquisition module which is capable of acquiring second additional information related to a second calendar from another electronic device, an output module which relates to the first additional information and the second additional information with the first calendar and outputs the resulting information, and a control module which performs processing based on a user operation on the second additional information of the first calendar.

An embodiment will further be described with reference to the drawings.

An electronic device related to a calendar according to the invention may be configured to be stand-alone or incorporated in a set-top box, a TV apparatus, a recorder, a mobile terminal, or the like. As an example, a case where an electronic device and an information processing method according to the embodiment have been applied to a TV apparatus will be explained.

The electronic device of the embodiment includes a unit that displays not only viewing content but also a service menu related to the content in list form when an instruction to start a cloud service has been given while content is being viewed and a unit that switches and displays related service menus according to a display state.

According to another embodiment, the electronic device includes an overall controller that can connect to a network and a view control module. With the overall controller being out of communication with the network, the view control module can demonstrate a menu image to be obtained if the overall controller goes into communication with the network.

The overall controller includes a login data management module and a communication data management module. The login management module manages a common login identifier for more than one person and a dedicated login identifier for an individual. The communication data management module distinguishes between communication data corresponding to the common login identifier and communication data corresponding to the dedicated login identifier, thereby selecting a display output.

The communication data management module controls communication data corresponding to the dedicated login identifier privately when the common login identifier is in a login state.

The server may manage login states and logout states of a large number of electronic devices (clients) in a table. In addition, the login management module may transmit a login identifier currently in a login state to the server periodically. This enables the server to ascertain the login states of a large number of electronic devices (clients) more accurately.

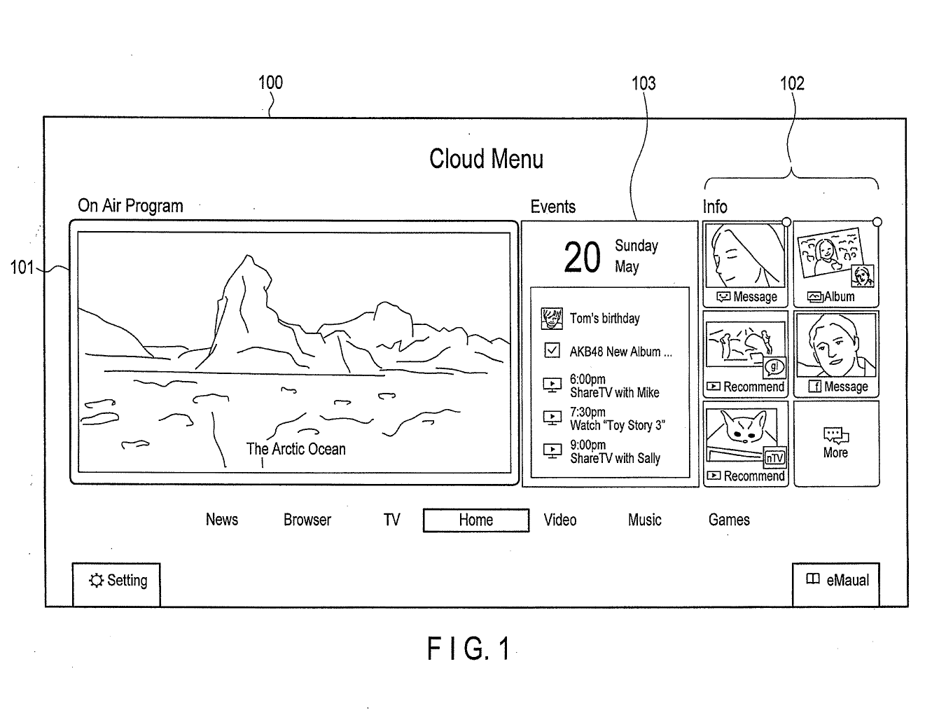

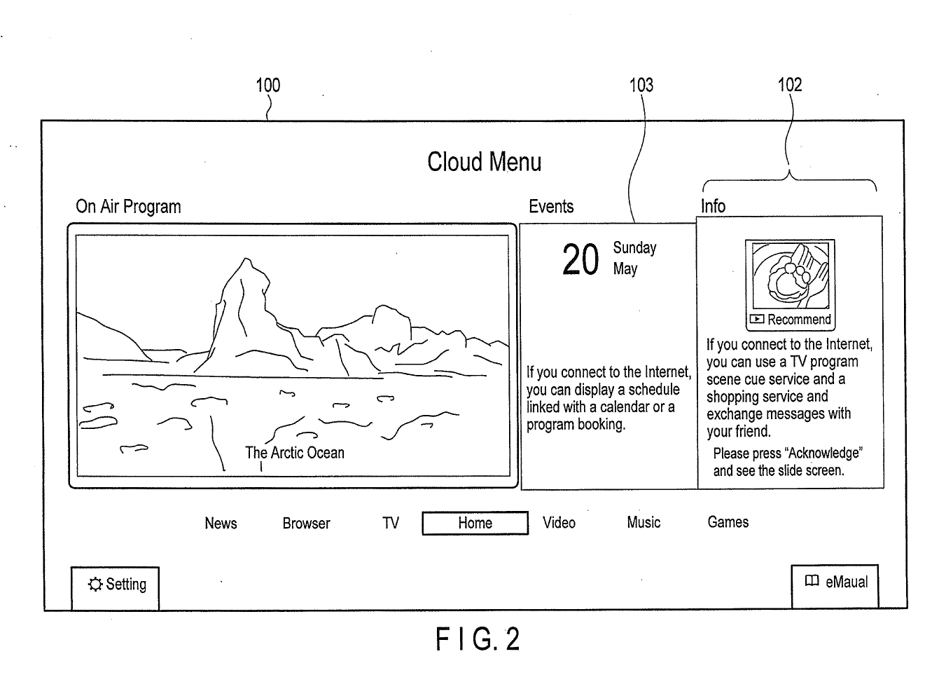

FIGS. 1 and 2 each show an example of a menu image in a demonstration state. In a display area 101 on the left side of a screen 100, an image of a program currently being broadcast or an image of a program being reproduced from a recording device is displayed. In a display area 102 on the right side of the screen 100, a plurality of small-sized guide images are displayed, increasing in number as follows: one, two, three, . . . . After the number of guide images in the display area 102 has reached, for example, six (see FIG. 1), for example, the message “If you connect to the Internet, you can use a TV program scene cue service and a shopping service and exchange messages with your friend” is displayed in the display area 102 as shown in FIG. 2. In a display area 103 in the center, a calendar is displayed together with a brief summary of information on various events of the day (FIG. 1). Then, each time a certain period of time has passed, the message “If you connect to the Internet, you can display a schedule linked with a calendar or program reservation” is displayed in the central display area 103 as shown in FIG. 2.

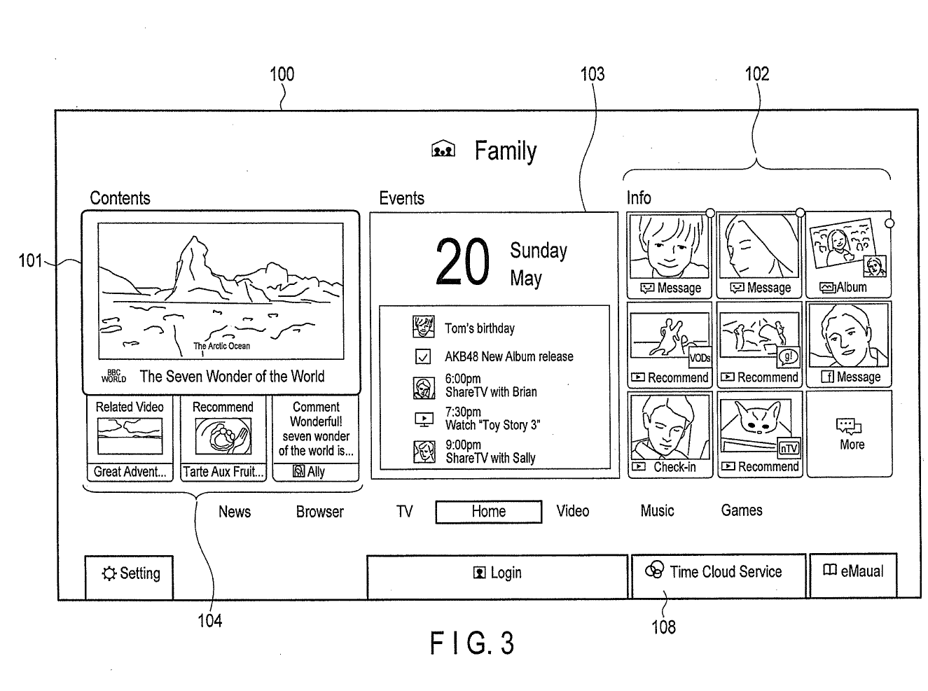

FIG. 3 shows a state where the screen 100 is displayed when the electronic device has been connected to the Internet and login has been started with a family ID. In the display area 102, guide images for various transmit-receive boxes to receive notices and recommended data from your family or friends are displayed. The transmit-receive boxes include an outlook, a mail, a message, and a recommended data box. A unique name can be added to a screen frame representing each transmit-receive box. Alternatively, a favorite image can be selected from an image file and added as a guide image. When a message or recommended data has arrived at the transmit-receive box, a corresponding guide image is displayed so as to be marked with, for example, a circle, changed in the frame color, or changed in the frame brightness repeatedly. When a plurality of recommended data items have arrived at the transmit-receive box, a plurality of circles may be displayed so as to be added to corresponding guide images. Alternatively, a number representing the number of received recommended data items may be displayed.

The transmit-receive box (the state of the display area 102 in FIG. 3) can be used for communication between, for example, family members or between family members and their friends. There may be a case where a photo album is received from a friend or a brother living in a distant place. In addition, there may be a case where recommended data is received from a friend. The recommended data includes, for example, recommended program information and recommended shopping information. It further includes recommended scene information and recommended performer information. An example of using the guide image will be explained later.

In addition, a plurality of function-related guide images are displayed in an area 104 under the area 101. The function-related guide images are used when the user operates the electronic device in connection with a reproduced image displayed in the area 101. The details of an example of using the guide image will be explained later. When communication regarding the reproduced image displayed in the area 101 is being performed between the user and an external server (or another user), the guide image can be used.

<Example of Using Guide Images in the Display Area 102>

The user can operate, for example, a remote controller (for example, a mobile terminal may have a remote controller function) to move a cursor (also referred to as a focus) to a desired guide image (for example, a guide image for a message from a mother to her child). The guide image may be referred to as an operation button. The cursor is displayed as, for example, a frame enclosing a guide image. Alternatively, the brightness of a guide image on which the cursor is focused is higher than that of the rest, that is, the guide image is highlighted. When the cursor is located on a desired guide image, an acknowledge button on the remote controller is pressed (or clicked with a click button), causing a transmit-receive box corresponding to the guide image to be opened, with result that, for example, a message is displayed. For example, the whole or half of the area 102 can be used for the massage.

In addition, the user can operate the remote controller to open a transmit-receive box for recommended data. The recommended data may be, for example, recommended program information on a recommended program or recommended shopping information sent from a friend. At this time, suppose the user has got interested in the recommended program and wanted to watch the program. At this time, when the user moves the cursor to a selection button for the displayed recommended program information and presses the acknowledge button, the TV apparatus can start to reproduce the program automatically. In this case, the reproduced image of the program may be displayed on a small screen. Then, when the user has pressed the acknowledge button, the reproduced image may be displayed on a large screen.

The transmit-receive box can be used to send a message to the receiver's transmit-receive box or mobile terminal. The recommended program information is displayed as, for example, a title name, a scene of a part of the program, a performer's name, or an image of the performer. The recommended program information further includes a broadcast channel, broadcast time and date, such information as performer's prologue, and a content server address.

A method of causing the TV apparatus at this time to acquire program content includes a first method of driving a recording device connected to the TV apparatus to acquire program content and a second method of acquiring program content by downloading the content from a content server via the Internet. In the first method, a program list search function for a program recorded in the recording device operates. In the second method, the address of a server with content included in the preceding recommended program information is used.

The recommended program information may include data processed for the user to acquire the program content easily. That is, the program information recommended by the friend is uploaded from the friend's device to the server. On the server, the recommended program information is processed into program information the user can use. The reason the recommended program information is processed is that a broadcast may differ in broadcast channel, broadcast time slot, or the like from region to region. Therefore, program information is processed (for example, the broadcast channel, broadcast time slot, and the like are processed) on the server so that the user can easily search for the same program as that recommended by the friend and obtain the program and then is offered to the user. The method of acquiring recommended program information further includes a method of acquiring the information from a calendar, which will be explained later.

In addition, using a guide image in the display area 102, a mail, a short message, or the like can be transmitted to a family member or to a friend entered in a management module that manages the guide image. The friend in this case is a friend common to the family members. Information on another family or a friend common to the family members is recognized by a home management module that stores and manages home guide images and is entered in the management module.

<Example of Using Guide Images in the Display Area 104>

For example, suppose a drama in a program (displayed in the area 101) the user is now watching has a scene the user likes or a scene where the user's favorite performer has appeared. In such a case, the user operates the remote controller, selects a recommended guide image, and presses the acknowledge button. Then, program information on the program the user is now watching is uploaded to a server as attention (or notice) program information. The server can use the attention program information as a material for creating recommended program information and/or information for creating a tag list for the program. Since attention program information on various programs is sent from many viewers to the server, the server can perform statistical processing on the basis of the attention program information and create a program information list of programs ranked in descending order of popularity.

In addition, the user can operate the remote controller to select a comment guide image and press the acknowledge button. Then, a screen that prompts the user to input a short message about a program (a program image displayed in the area 101) the user is watching appears, enabling the user to input a message. The user can input a message from, for example, the remote controller or the keyboard display of the mobile terminal.

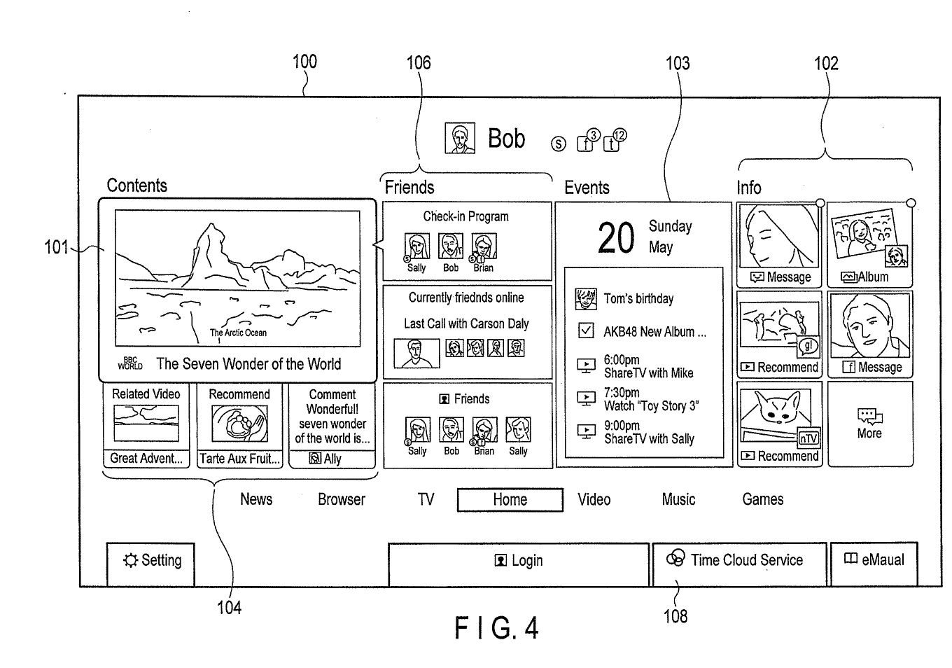

FIG. 4 shows a display state of the screen 100 when the electronic device has been connected to the Internet and logged on to with a personal ID. In the screen 100, a display area 106 for guide images to perform communication with a friend is obtained between the area 101 and the area 103. In the display area 106, there are, for example, three types of guide images. In an upper guide image (Check-in Program), a list of others (friends) watching simultaneously a program the user is now watching is displayed. In a middle guide image (Currently friends online), although the electronic device has been connected to a network, a list of others (friends) watching a program differing from the program the user is now watching is displayed. In a lower guide image (Friends), a list of others (friends) with the electronic device not connected to the network is displayed. The login state of the electronic device is transmitted to the server periodically. Therefore, the server can distinguish between a user not connected to the network, a user connected to the network, and a user who is connected to the network and is watching the same program. The server is monitoring the statuses of a plurality of users. Accordingly, the electronic device can present three types of guide images as shown in the display area 106.

<Example of Using Guide Images in the Display Area 106>

For example, when son B of friend A appears in a drama of a program the user is now watching, the user may want to inform friend A or friend A's family of this. In addition, when friend A is searching for stray dog C and the user has heard the news about stray dog C, the user may want to inform friend A or friend A's family of this. In those cases, the user can use guide images displayed in the area 106.

The user can operate the remote controller to select, with a cursor, a guide image in which a desired friend is displayed and press the acknowledge button. Then, there appears a screen that enables the user to send a message to the selected friend.

For the communication, the user can use guide images in which a recommendation and a message displayed in the display area 102 have been written. The user can operate the remote controller to select, with the cursor, a guide image in which a desired image has been displayed and press the acknowledge button. Then, a message for a family member or a person entered in the transmit-receive box for the selected image can be transmitted. Guide images in the display area 106 can be used primarily for private communication.

<Example of Using a Guide Image in the Display Area 103>

In this guide image, not only is a calendar displayed, but also the titles of events and a schedule of the day are displayed briefly. If the user wants to know detailed information on the events or schedule, the user selects the title of an event or a schedule with the cursor and clicks the title, thereby further displaying detailed information. The detailed information can be browsed with, for example, a URL.

In the calendar, the user's schedule can be written. When the display area for the calendar has been selected with the cursor, calendar use items are displayed. When a schedule write item has been selected, a schedule can be input from the remote controller or mobile terminal.

<Movement of Operation Screen>

The guide images shown in FIGS. 2, 3, and 4 excluding a viewing image in the area 101 can be displayed on a mobile terminal which is a touch input operation module with a display module. That is, the electronic device can move the guide image and a manipulate signal corresponding to the guide image to a mobile terminal via a communication function of the TV apparatus. This enables the mobile terminal to maintain communication with the TV apparatus and manipulate the electronic device making use of guide images as described above.

<Cloud Service Button>

On the screen 100, a button 108 (whose name and display position are not restricted to this embodiment) called, for example, “Time Cloud Service” is displayed.

Now, suppose, while watching content displayed in the area 101, the user selects the cloud service button 108 with the cursor and clicks the button 108 to give a cloud service instruction. Then, a cloud service application in the apparatus can be started. When the cloud service has been started, not only viewing content but also a service menu related to the content is offered from a time cloud server, enabling the service menu to be displayed in list form. It is possible to switch between related service menus according to a display state. Cloud services are available in various forms and will expand in various fields. As for cloud services, some typical examples will be explained later. The guide images shown in FIGS. 2, 3, and 4 may be activated when the button 108 is turned on and the apparatus is connected to the time cloud service server. When the cloud service application is activated, a specialized key provided on the remote controller may be operated.

The apparatus may be connected to the cloud service server when a specific button on the remote controller or mobile terminal has been operated.

<A Block Configuration of the Electronic Device>

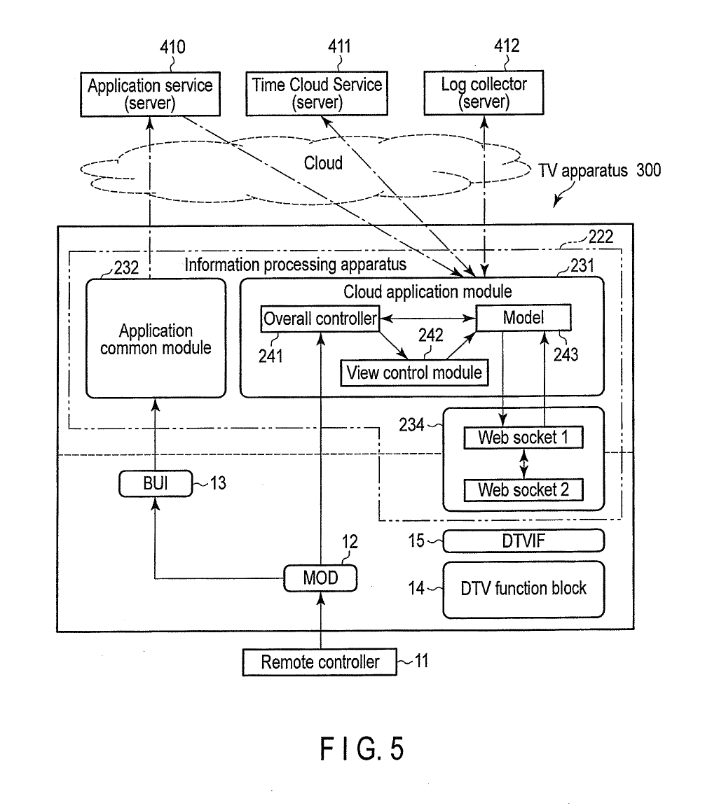

FIG. 5 shows an overall configuration of the TV apparatus 300 to which the electronic device and information processing method according to the embodiment have been applied. In FIG. 5, the basic functions (including television signal reception, demodulation, control signal processing, 3-D-related signal processing, recording, audio processing, video processing, and a display function) of a digital television receiver (hereinafter, abbreviated as a DTV) are collectively called a DTV function block (or module) 14. The DTV function block 14 is connected to an electronic device 222 via a DTV interface 15. The electronic device 222 may be referred to as a browser section.

In the embodiment, the electronic device 222 includes a cloud application module 231, an application common module 232, and a socket module 234. This classification is not restrictive. The cloud application module 231 may be defined as the electronic device 222.

The socket module 234 includes a server web socket viewed from the DTV interface 15 and a client web server viewed from the browser.

The cloud application module 231 includes an overall controller 241, a view control module 242, and a model 243. The overall controller 241 performs various event processes in response to a command or an instruction. The overall controller 241 controls the view control module 242, thereby realizing various drawing processes. The view control module 242 can obtain various images and control signals in the aforementioned screen 100. The images and control signals based on the operation of the view control module 242 pass through, for example, the model 243 and socket 234 and are displayed as images and control buttons on the display module of the TV apparatus.

In this description, the control module may be referred to as a controller.

The model 243 can access a server, acquire information from a server, transmit information to a server, operate a DTV, and receive data from a DTV. Therefore, the model 243 can receive a message from the DTV and transmit the message to the server. In addition, the model 243 together with the view control module 242 can display the message received from the server on the screen of the display module of the DTV. As for servers, there are an application service server 410, a time cloud service server 411, and a log collector server 412. There are still other servers (not shown).

The user can manipulate the remote controller 11 to control the DTV and electronic device 222. A manipulate signal from the remote controller 11 is distributed at a moderator 12. A key event distributed for use with the cloud application module 231 is input to the overall controller 241. A key event distributed for use with the application common module 323 is input to the application common module 232 via a browser interface 13. The application common module 232 can request a specified application from an application server 410 according to an application request command. The application sent from the application server 410 is taken in by the cloud application module 231 via the model 243. The log collector server 412 can collect logs used in the electronic device 222 and other connection devices.

The time cloud service server 411 can be connected to other various servers and other electronic devices via the network. The time cloud service server 411 can send various service data items to the electronic device. The time cloud service server 411 can relate video content to scene information or a tag list created by a metadata maker or a user. The related data items are arranged on, for example, a table.

Each block and its operation (including the aforementioned operations and operations described below) shown in FIG. 5 may, of course, be realized by a set of instructions constituting software (also referred to as a program). Of course, a processor or a central processing unit (CPU) for realizing data processing with software may be incorporated in each block of FIG. 5. The software, which is stored in a memory (storage medium), can be upgraded. The data (software) in the memory can be read by a computer.

The DTV, which includes a plurality of digital tuners, can receive a plurality of channels at the same time. When signals on a plurality of channels have been demodulated, a plurality of streams are obtained. Each stream includes packets of a television program, a control signal, and the like. The streams of a plurality of programs on a plurality of channels are recorded into, for example, a hard disk drive (HDD) connected via a USB connection cable. The HDD can also record management information for managing program information on recorded programs.

<Recording Reservation, Viewing Reservation, Recording History, and Viewing History in the DTV>

In the TV apparatus 300 to which the electronic device and information processing method according to the embodiment have been applied, a recording reservation function, a viewing reservation function, a recording history function, and a viewing history function have been constructed.

The recording reservation means that the user plans to record a desired program into a desired recording device (for example, an HDD). The recording reservation function creates a program listing from, for example, electronic program guide (EPG) data and displays the listing. The user operates the remote controller to select a desired program with the cursor, thereby reserving recording. This causes the desired program to be recorded in, for example, an HDD. When a plurality of recording devices are connected to a home network, the user can specify an HDD in which programs are to be recorded.

The recording history is information on the recording reservation or programs recorded by automatic recording. Recording time and date and recorded program information (data on broadcasting station name, broadcast time slot, and the like) are included in the recording history information.

The viewing reservation means that the user plans to reproduce a desired one among a large number of programs already recorded in the HDD. Reservation information includes an HDD that has stored the program, a broadcasting station name of the relevant program, a program name of the program, and a reproduce start time of the program.

The viewing history includes program information (data on a recording device, a broadcasting station name, a broadcast time slot, and the like) on a program reproduced on the TV apparatus 300.

Each of the recording reservation, viewing reservation, recording history, and viewing history can be managed by each family member. In addition, each of them can be managed as open information shared by all the members of the family. This is because data including recording reservation, recording history, viewing reservation, and viewing history is managed by family and individual login identifiers at the management module.

<Relationship Between the Time Cloud Service Server and the Electronic Device>

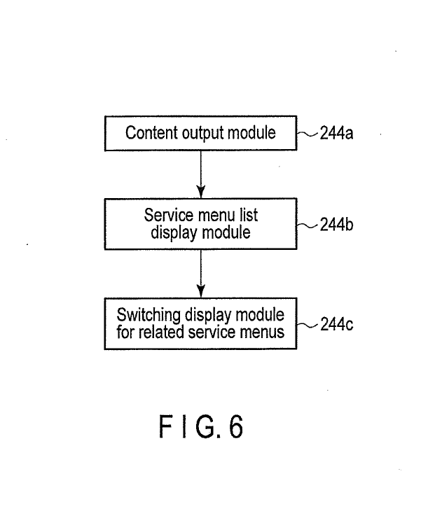

FIG. 6 shows a configuration of a module (in either software or hardware) composed of the overall controller 241, view control module 242, and model 243 in FIG. 5. A content output module 244a outputs viewing content to the display module. When an instruction to request a service from a specific server has been input while content is being output to the display module, a service menu list display module 244b can cause the display module to display a service menu related to the content in list form. A switching display module 244c can switch to and display a further related service menu according to the display state of the service menu in response to the input of a subsequent instruction. Hereinafter, various service functions related to this function will be explained.

<Scene Information Function (Also Referred to as Scenefo)>

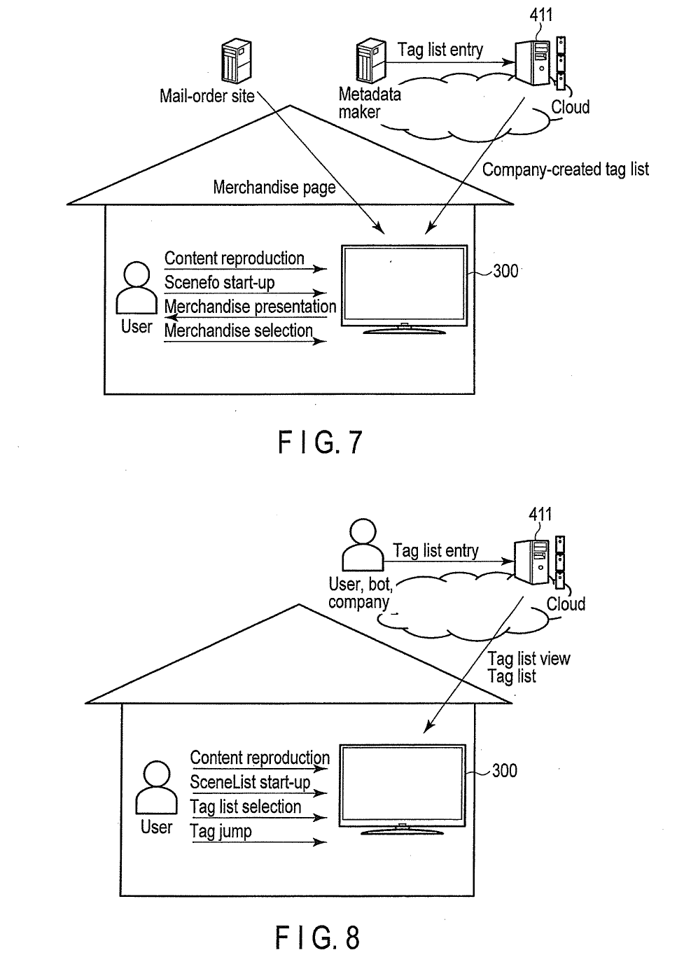

FIG. 7 schematically shows the relationship between the TV apparatus 300 and the time cloud service server 411 when a scene information function (Scenefo) is used. In the embodiment, a service where video content is connected to scene information is used as scene information, which is abbreviated as, for example, “Scenefo.”

While the user is watching a program, if the user has found a curious scene, the user presses, for example, the “Scene information key” on the remote controller (preferably in a state where the time cloud service button 108 of FIG. 4 is on). Alternatively, when a curiosity button (a curiosity key) is displayed in the area 104, the user clicks the key. Then, the scene information service application starts. At the same time, the browser is also activated. Next, the user can browse a tag list or a scene list obtained by collecting scenes related to curious scenes as a plurality of tags. More than one tag list or one scene list may be used. In a normal tag list, a plurality of tags have been created in the same program. In a scene list, scenes in the same program and scenes in another program may have been created in a unified manner. The tag list and scene list are also included in scene information. The scene information further includes various pieces of information as explained later.

Some tag lists or scene lists may be created by metadata makers or general users and uploaded to the time cloud service server 411.

Here, a tag list or a scene list is interval information whereby a scene in which the same performer appears can be segmented in units of several seconds or several tens of seconds in, for example, a certain program. As the interval information, a reproduction elapsed time (referred to as a relative time) since the starting position of a program is used. A pair of the starting time of a scene and the ending time of the scene determines one unit of scene.

The time cloud service server 411 refers to scene information (a program name, a channel, a time location (also referred to as a relative time since the starting position) on a program of a curious scene) created on the basis of the manipulation of “Scene information key,” thereby determining a corresponding tag or scene. The tag is one unit of tag constituting a tag list. The tag list is normally created in the same program. The scene is one unit of scene constituting a scene list. The scene list can be created, extending not only into a list of a program the user is now watching but also over a plurality of programs. A scene list created over a plurality of programs can be created from a plurality of programs, for example, in the same or a similar genre.

The scene list is attached with, for example, such a name or a comment as represents a program. A plurality of different scenes may have been created for one scene in a program. The reason for this is that a scene the user is curious about may be a scenic backdrop, a car appearing in the scene, or an actor driving the car in the scene. Therefore, a scene list about landscapes, a scene list about cars, a scene list about actors, and the like may be created.

As described above, when the user operates the “Scene information key” in a certain scene of a program, scene information on the corresponding scene is sent from the time cloud service server 411 to the electronic device. That is, the apparatus includes a module that displays not only viewing content but also a service menu related to the content in list form when an instruction to start a cloud service has been given while the user is watching the content.

A plurality of scenes regarding the scene information are displayed, for example, on the right side of the screen 100. The user can refer to a comment or a name displayed together with the scene, select a desired scene by manipulating the remote controller, and press the acknowledge button. Then, on the screen 100, various scenes concerning the selected scene are displayed in the form of category selection buttons, including “Merchandise information,” “Outlet information,” “Regional information,” “Personality information,” and “Tag reproduction.”

The display state of the screen 100 at this time means that more detailed information about the merchandise, outlets, regions, personalities, “Tag reproduction,” and the like appeared in the curious scene can be provided for the user. When “Tag reproduction” has been selected, this means that a tag can be reproduced. That is, the apparatus includes a module that switches and displays related service menus according to the display state.

When the user has selected, for example, the “Merchandise information” button, the screen 100 goes into a merchandise selling site browsing state. This is because scene information sent from the time cloud service server 411 includes not only scene list or tag list data but also a homepage address of the selling site or the like as extended link information.

When the user has selected the “Outlet information” button, the screen 100 can go to a guide site for outlets appeared in the curious scene. When the user has selected the “Regional information” button, the screen 100 can go to a guide site for a tourist board, an administrative institution, or the like in the region. At this time, information sent from the time cloud service server 411 may include map information created on the basis of GPS information. This enables the user to check whether an outlet or the like is near the user's house, looking at a map.

In addition, the user has selected the “Personality information” button, the screen 100 can move to a guide site for a profile of the actor, another program in which the actor appears, a tour of the theater, support group information, and the like. Moreover, another key may be caused to also function as “Scene information key.”

<Scene List Function (Also Referred to as SceneList>

FIG. 8 schematically shows the relationship between the TV apparatus 300 and the time cloud service server 411 when a scene list function (SceneList) is used. The scene list function includes a module similar to that of the scene information function (Scenefo).

For example, in a soccer broadcast, the user may want to see a goalshot scene or a scene of a specific player appearing on the field. Alternatively, in a sumo broadcast, the user may want to see a scene of a specific wrestler (a sumo wrestler) appearing in the ring.

In such a case, when the user currently watching a program particularly has wanted to view a specific scene, the user presses, for example, the “Scene list key” on the remote controller (preferably in a state where the time cloud service button 108 of FIG. 4 is on). Then, the scene list function starts, enabling the user to look at a scene list or a tag list of scenes equivalent to or similar to the scene the user wants to view.

The tag list is normally created in the same program. The scene list may include not only a list of the program the user is now watching but also a scene list covering a plurality of programs. For example, in a sumo broadcast, a sumo match in which a specific wrestler appears is played once a day and sumo broadcasts for a plurality of days have been recorded. Therefore, there is a scene list of a plurality of programs. The scene list is attached with, for example, such a name or a comment as represents the program. A plurality of scene lists or tag lists may have been created for one scene of a program. The scene list or tag list is also provided by the time cloud service server 411. That is, the apparatus includes a module that displays not only viewing content but also a service menu related to the content in list form when an instruction to start a cloud service has been given while the user is watching the content.

When the user has selected a desired scene list name and pressed a play button, a scene according to the selected scene list or tag list is reproduced. The user can select a desired scene list name and press, for example, the acknowledge button. After the user has pressed the acknowledge button, scene cells constituting the scene list are displayed in array form. The array is in the order of time passage. Here, when the user has moved the cursor to the position of a desired scene cell and pressed the play button, reproduction is started with the scene specified with the cursor in the order in which the scenes have been arranged. That is, the apparatus includes a module that switches and displays related service menus according to the display state.

<Scene Play Function (Also Referred to as ScenePlay)>

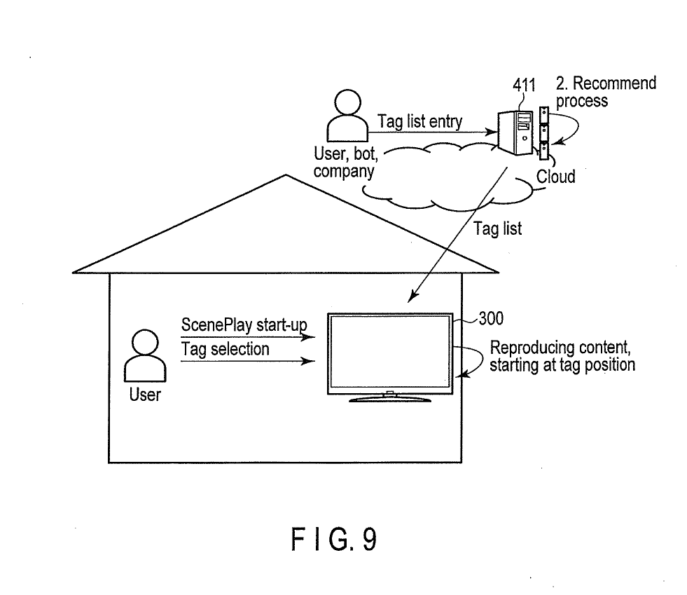

FIG. 9 schematically shows the relationship between the TV apparatus 300 and the time cloud service server 411 when a scene play function (ScenePlay) is used. The scene play function includes a module similar to that of the scene information function (Scenefo).

As for a long-time program or a program watched halfway, the user may want to reproduce the program, starting with a part of the program. In addition, the user may want to reproduce the program, starting with a favorite scene. In such a case, the user clicks the “Scene play” button (guide image) displayed in, for example, the area 104 of the screen 100 (preferably in a state where the time cloud service button 108 of FIG. 4 is on). Then, the image arrangement is changed and a plurality of small images of representative recommended scenes are displayed for the program the user is currently watching. For example, like the guide images shown on the right side of FIG. 3, a plurality of small images of representative recommended scenes are displayed. That is, the apparatus includes a module that displays not only viewing content but also a service menu related to the content in list form when an instruction to start a cloud service has been given while the user is watching the content.

On the screen 100 in FIGS. 1 to 3, a guide image for “Scene play” is not displayed. However, various guide images can be displayed by moving the cursor to any one of the guide images in the area 104 and operating the scroll key on the remote controller. Since a guide image for “Scene play” is among the guide images, the user clicks the guide image. Then, a plurality of small images of representative recommended scenes are displayed in connection with the program the user is currently watching.

The user can start to reproduce the program, beginning with a scene of the small image by operating the remote controller to select the desired small screen with the cursor and pressing the play button. That is, the apparatus includes a module that switches and displays related service menus according to the display state.

A recommended scene is created and prepared at, for example, the time cloud service server 411. Various method of creating a recommended scene can be considered. The time cloud service server 411 collects, for example, curious scene information and/or recommended data from many clients (users). Then, statistics on program information on curious scene information and/or program information included in recommended data are taken. By the statistical processing, a plurality of scenes specified a number of times in program information are ranked on a program basis. A plurality of scenes high in the rank in a program are set as representative scenes and representative scene information corresponding to the representative scenes is created. By doing this, in each program, a plurality of representative scenes are determined. The representative scene information includes the name of a program, the broadcast date and time of the program, and a relative time required to start the reproduction of a representative scene when the program is reproduced from the beginning.

In addition, the time cloud service server 421 is configured to be capable of receiving program recording destination (for example, a hard disk drive, a DVD, or a BD) information and recorded program information from the user's electronic device and ascertaining which program has been recorded in which recording medium. Therefore, when creating representative scenes, the TV apparatus can read content including the representative scenes from the recording medium at high speed and present a plurality of representative scenes.

<Selection, Switch, or Transition of the Scene Information Function (Scenefo), Scene List Function (SceneList), and Scene Play Function (ScenePlay)>

The user may want to move to the scene list function (SceneList) or scene play function (ScenePlay) after having entered (a) the scene information function (Scenefo). In addition, the user may want to move to the scene play function (ScenePlay) or scene information function (Scenefo) after having entered (b) the scene list function (SceneList). Moreover, the user may want to move to the scene list function (SceneList) or scene information function (Scenefo) after having entered (c) the scene play function (ScenePlay).

The electronic device has a function switching function for such a case. Various methods of switching functions can be considered. For example, after a scene list or a tag list has appeared, the scene information key, scene list key, and scene play key may be displayed, prompting the user to select any one of them. Alternatively, the scene information key, scene list key, and scene play key may be provided on the remote controller or displayed on the display module of a mobile terminal.

Furthermore, a scene-related function switching key may be prepared. The switching key may be configured to be operated repeatedly to switch the functions cyclically in this order even if any function is in operation: the scene information function (Scenefo), scene list function (SceneList), and scene play function (ScenePlay).

<Control Information Used when the Scene Information Function (Scenefo), Scene List Function (SceneList), or Scene Play Function (ScenePlay) is in Operation>

The time cloud service server 411 can further transmit control information for controlling a TV function to the electronic device. The time cloud service server 411, which has an information extended linkage function, can relate to data items transmitted from a metadata database server and many users with one another to create extended linkage data. The time cloud service server 411 has a correlation table for correlating data items with one another. Various methods of correlating data items with one another can be considered. For example, there is a method of correlating various data items with one another using a common identifier. In addition, sub-identifiers may be added to the identifiers, thereby classifying the degrees of correlation of data items or the types of data items related to one another on the basis of the sub-identifiers.

As described above, scene information that relates to program information with outlets, merchandise, or the like can be created.

The expanded linkage data may include a control signal that controls the TV function automatically. For example, when the DTV function block 14 of the TV apparatus includes a 3D signal processing module, a control signal for bringing a content process into a 3D processing mode can be transmitted. The DTV function block 14 of the TV apparatus can respond to the control signal. The 3D process includes the process of converting a 2D signal into a 3D signal. The 3D process further includes the process of supplying a 3D signal to a 3D display. The 3D display is available as a display that enables the user to see a 3D image with the naked eye or as a display that enables the user to see a 3D image by use of glasses. Therefore, when having determined that a scene or an image the user is going to see should be viewed in three dimensions and that the TV apparatus has a 3D function, the time cloud service server 411 can transmit a control signal that brings the TV apparatus into a 3D processing state automatically.

In addition, the time cloud service server 411 sends an audio control signal and/or an audio signal corresponding to a scene. The DTV function block 14 of the TV apparatus can respond to the audio control signal and/or audio signal. Particularly when the scene information function and scene list function are in operation, the TV apparatus is in a reproduction situation differing from a situation where a normal program is reproduced continuously. Therefore, the audio system of the TV apparatus outputs music (for example, BGM) or sound suitable for a scene.

Furthermore, it may be better to adjust the brightness or the color of an image according to a scene the user is watching. Even in such a case, the time cloud service server 411 can include image adjustment data in extended linkage data and transmit the resulting data according to the user or scene. For example, suppose a scene list has been requested in a situation where, for example, the electronic device has been logged on to with a home login ID. Then, it is assumed that a specific scene (for example, a scene of violence) is in a plurality of scenes specified by the scene list. In such a case, the time cloud service server 411 may include a control signal that causes the reproduction of the specific scene to be skipped in the extended linkage data and transmit the resulting data to a client.

The time cloud service server 411 can receive from the electronic device not only the login identifier but also specification information including manufacturer information on, for example, the TV apparatus or mobile terminal and display capability and store them. The reason for this is that the display capability, control method, and the like of the TV apparatus may differ from maker to maker. When transmitting a control signal to the electronic device (client) while the scene information function (Scenefo), scene list function (SceneList), or scene play function (ScenePlay) is operating, the time cloud service server 411 can transmit a control signal suitable for the client. In addition, when transmitting display data, such as a message created by the time cloud service server 411, the time cloud service server 411 may transmit different languages, including Japanese, English, French, Korean, Chinese, German, and Spanish, and/or sounds according to the setting of the electronic device (client).

Furthermore, the time cloud service server 411 is configured to transmit a power-saving instruction or a power-saving assistance request signal when a TV apparatus including an electronic device (client) has a power-saving function. The time cloud service server 411 can receive a power demand situation and power forecast information from, for example, a power plant company. When the power supply quantity is getting tight with respect to the power consumption, the time cloud service server 411 can inform each electronic device of power-saving assistance to achieve power saving.

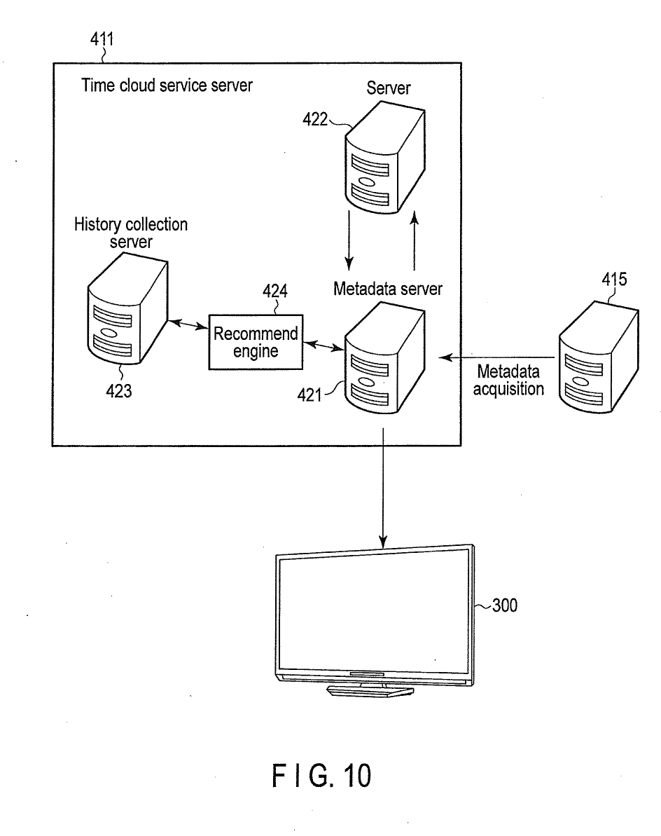

FIG. 10 shows an example of the organization of servers constituting the time cloud service server 411.

Numeral 421 indicates a metadata server. The metadata server 421 can receive various metadata items from a data creation server 514 in an outside data creation company. Metadata, which is program information, includes many pieces of information on programs, including broadcast channels, broadcast times, and performers. Metadata is used to create scene information, a tag list, a scene list, and the like at the metadata server 421. There is control information attached to a tag list, a scene list, and scene information.

In addition, the metadata server 421 can enter a tag list and/or a scene list into a tag list creation server 422. Moreover, the metadata server 421 can acquire a tag list and/or a scene list from the tag list creation server 422 at the request of a client (electronic device) and provide it for the client (electronic device). The metadata server 421 can create scene information using metadata and transmit it to the client (electronic device).

The metadata server 421 collects, for example, curious scene information and recommended data from many clients (users) and transfers the collected data to a history collection server 423. The history collection server 423 takes statistics on program information on curious scene information and/or program information included in recommended data. By the statistical processing, a plurality of scenes specified a number of times in program information are ranked on a program basis. A plurality of scenes high in the rank in a program are set as representative scenes and representative scene information corresponding to the representative scenes is created. By doing this, in each program, a plurality of representative scenes are determined. The representative scene information includes the name of a program, the broadcast date and time of the program, and a relative time required to start the reproduction of a representative scene when a program is reproduced from the beginning.

When a client has requested a scene play, the metadata server 421 can cause the server 423 to send back representative scene information on the requested program to the client.

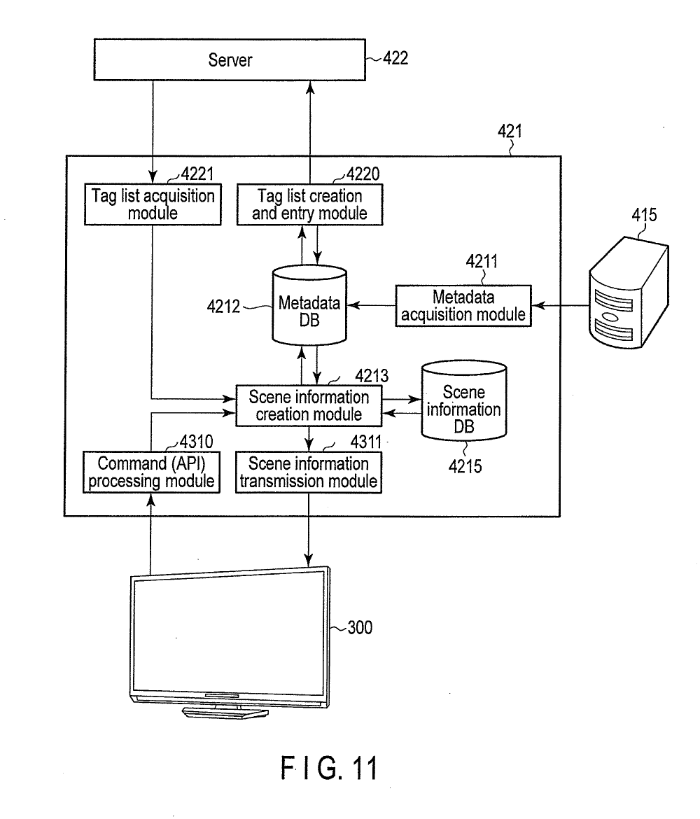

FIG. 11 shows an internal configuration of the metadata server 421. A metadata acquisition module 4211 receives various metadata items from the data creation server 514 and stores the metadata items in a database unit 4212. A tag list creation and entry module 4220 creates a tag list using metadata and enters the created tag list into the server 422. A tag list acquisition module 4221 can acquire a tag list from the tag list creation server 422 by request from a client (electronic device) and provide the tag list for the client (electronic device). A scene information creation module 4213 creates scene information using metadata and stores the crated scene information in a scene information database unit 4215. At the request of a client, an information transmission module 4311 transmits scene information and/or a tag list and/or a scene list to the client.

A command processing module 4310 receives an instruction and/or information from the client and reflects it in the operation of the metadata server 421.

The aforementioned blocks show only representative ones. The database unit 4212 stores various data items in addition to the above-described items. Moreover, various control blocks are used to achieve operations described later.

The metadata server 421 performs information extended linkage processing. For example, when a client (user or electronic device) has transmitted scene information on a curious scene to the metadata server 421 as described above, the metadata server 421 can transmit not only data corresponding to the request of the client but also the extended linkage data explained above. Therefore, the user obtains the convenience of being capable of using the extended linkage data effectively.

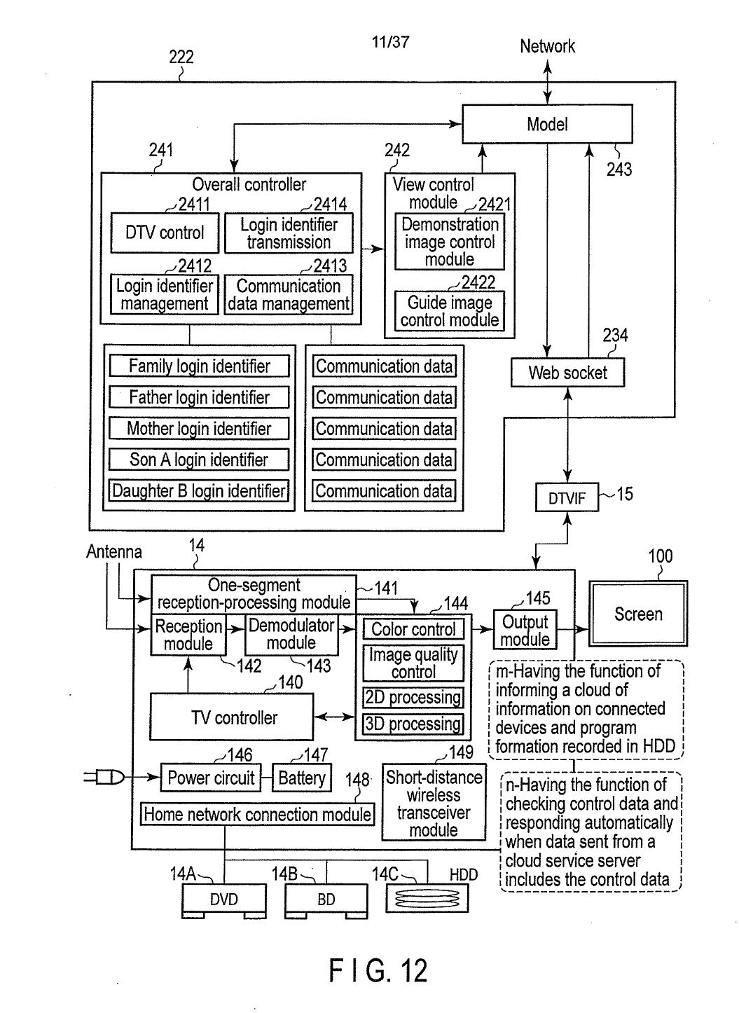

FIG. 12 shows a configuration of the electronic device 222 and DTV function block 14 together with the relationship between them. The overall controller 241 includes a DTV control module 2411, a login identifier management module 2412, a communication data management module 2413, and a login identifier transmission module 2414. The DTV control module 2411 may control the DTV function block 14 on the basis of a user operation or control various TV function blocks 14 on the basis of control data from the time cloud service server 411. When a login identifier explained in FIGS. 3 and 4 has been input, the login identifier management module 2412 controls the storage of the login identifier and manages family and individual identifiers as table data. The communication data management module 2413 manages communication data so that the communication data items may correspond to the individual login identifiers. For example, when the logged-in user has accessed an external server, the communication data management module 2413 manages its history data. The history data includes an access destination address, and transaction data. The communication data management module 2413 can also classify and store data items sent from the cloud service server 411 and use the data as display data. In addition, data including recording reservation, recording history, viewing reservation, and viewing history is managed by family and individual login identifiers.

The login identifier transmission module 2414 transmits the logged-in login identifier to the cloud service server 411. The cloud service server 411 manages login identifiers from many users and uses them when providing guide images as explained in FIG. 4.

The view control module 242 includes a demonstration image control module 2421 and a guide image control module 2422. This enables a demonstration image and a guide image as explained in FIGS. 1 to 4 to be provided for the DTV side.

The DTV function block 14 includes a one-segment reception-processing module 141 that receives a signal from an antenna, a reception module 142 that receives satellite broadcasting and terrestrial digital broadcasting, and a demodulator module 143. The reception module 142 and demodulator module 143, which include a plurality of tuners, can receive broadcasts on a plurality of channels simultaneously and demodulate them. A plurality of demodulated program signals can be converted into a DVD format at a DVD device 14A and recorded onto a digital versatile disc. Alternatively, the demodulated program signals can be converted into a BD format at a BD device 14B and recorded onto a Blu-ray disc. Moreover, in any stream, the demodulated program signals can be recorded onto a hard disk with a hard disk drive 14C. The DVD device 14A, BD device 14B, and hard disk drive 14C are connected to the DTV function block 14 via a home network connection module 148. The hard disk drive 14C may be of a type to be connected via a USB cable. The hard disk drive 14C may be based on a method capable of recording all the programs on a plurality of channels (for example, set six channels) simultaneously for, for example, about one to three weeks. This type of function may be referred to as a time-shift function. In addition, the hard disk drive 14C may be so configured that an additional hard disk drive can be provided.

The network connection device and recorded program information can be ascertained by a TV controller 140 and transmitted to the cloud service server 411 via the electronic device. In this case, the cloud service server 411 can ascertain the user's home network connection device and recorded program information. Therefore, when each scene is reproduced on the basis of scene list information, the cloud service server 411 can specify even a home connection device in which the various scenes have been recorded.

A program signal demodulated in the DTV function block 14 or a program signal reproduced from a recording medium, such as a DVD, a BD, or an HD (hard disk), is subjected to various adjustments (including bright adjustment and color adjustment) at a signal processing module 144 and is output to the screen 100 of the display module via an output module 145.

The DTV function block 14 includes a power circuit 146. The power circuit 146 can switch between a use situation of commercial power and a use situation of a battery 147 as needed. The switching between the use situations includes a case where the user performs the switching forcibly by operating the remote controller and a case where the switching is performed automatically on the basis of external information.

The cloud service server 411 can transmit a control signal to bring the TV apparatus into a 3D processing state automatically. Furthermore, the cloud service server 411 can transmit an audio control signal and/or an audio signal corresponding to a scene to the TV apparatus. Moreover, according to a scene, the cloud service server 411 can include image adjustment data in extended linkage data and transmit the resulting data.

The DTV function block 14 includes a short-distance wireless transceiver module 149. The DTV function block 14 can transmit and receive data to and from a mobile terminal via the short-distance wireless transceiver module 149. The mobile terminal can request an operation image from the DTV function block 14. When the DTV function block 14 has been requested to give an operation image, it can transmit a guide image as shown in FIGS. 3 and 4 to the mobile terminal. The user can control the electronic device making use of the guide image on the mobile terminal.

The DTV function block 14 can check control data sent from the cloud service server 411 and reflects the data in an operation state automatically.

Therefore, with the system, the electronic device basically transmits data (control signal corresponding to a scene information key, a scene list key, or a scene play key) acting as a trigger to a server via the network connection module in response to a first operation signal from the user. Next, the electronic device acquires extended linkage data sent back on the basis of the trigger data, classifies a first control signal (instruction) for automatic control included in the extended linkage data and a second control signal (instruction) corresponding to the second operation signal from the user, and stores them. They are stored in the overall controller or model. Then, the electronic device can perform an autonomic operation on the basis of the first control signal (instruction) and/or a heteronomous operation on the basis of the second control signal (instruction). The autonomic operation means operating in an autonomic manner. For example, this means obtaining a display image in the area 106 as shown in FIG. 4 and controlling the DTV function block 14. The heteronomous operation means waiting for a user operation and responding to a second operation signal when the second operation signal from the user is input. This operation includes the operation of responding to merchandise selection, the operation of responding to tag list selection, and the operation of responding to scene list selection as shown in FIGS. 6, 7, and 8. The extended linkage data further includes display data to be displayed. The display data includes various messages and albums. When having received a power-saving instruction from the time cloud service server 411, the DTV function block 14 can perform a power-saving operation. The power-saving operation includes, for example, the change of a full-segment reception state to a one-segment reception state, the reduction of the display area of the display module, and the change of commercial power use to battery use.

In addition, the DTV function block 14 can control the brightness of an area of a moving image in the area 101 so that the brightness may be higher than that of another area. That is, the DTV function block 14 can make the brightness of a guide image in the area 102-104 lower than that of a moving image in the area 101, thereby making it easier to see the moving image. To perform a specific operation, the DTV function block 14 can control the brightness of a guide image pointed by the cursor so that the guide image may get brighter.

The aforementioned apparatus can make effective use of a calendar. Hereinafter, a calendar display mode, a calendar using module, and a calendar using method will be explained.

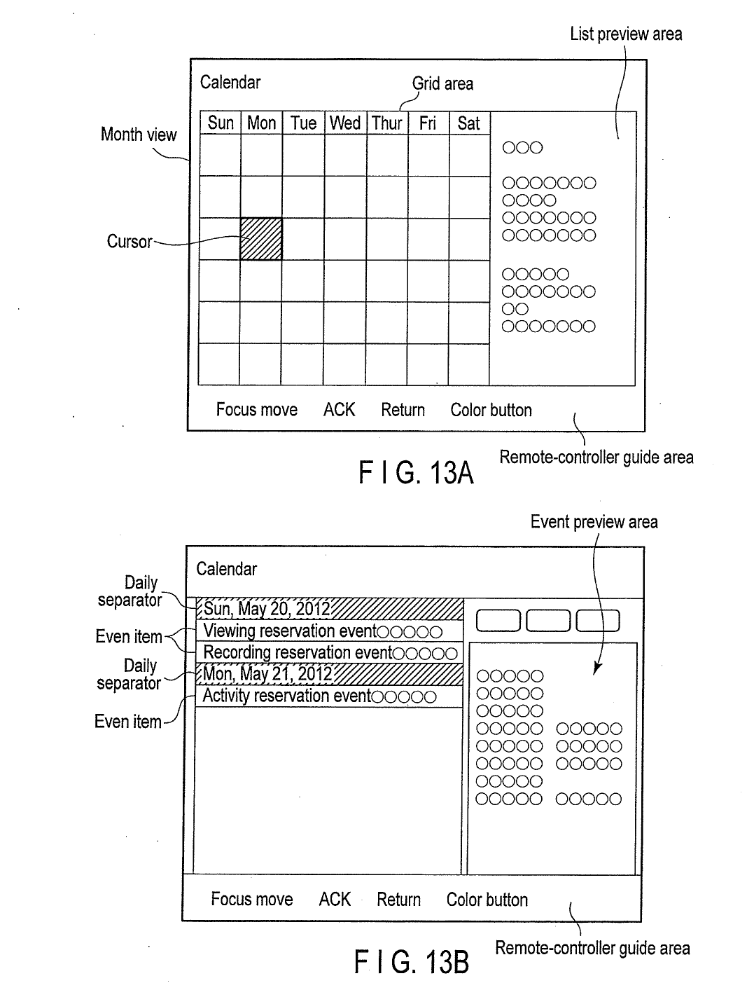

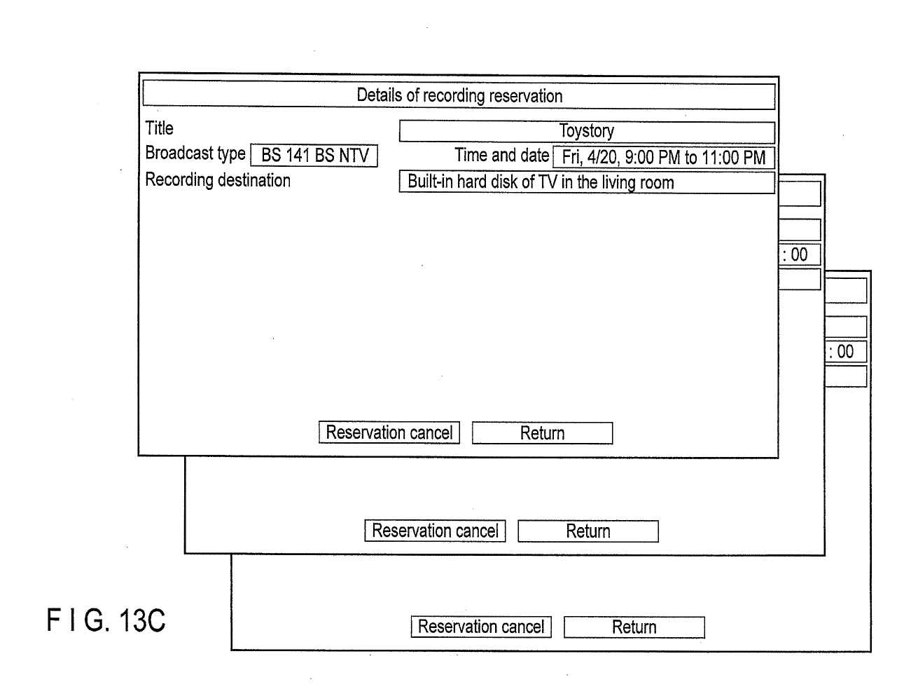

FIG. 13A shows a page-a-month calendar. The calendar includes a plurality of areas to each of which a name has been given as shown in FIG. 13A. A whole image is called a month view. An area for displaying a plurality of weeks is called a month grid area. On the right side of the image, a list preview area is further arranged. In addition, in the lower part of the image, a remote-controller guide area is arranged. A display state as shown in FIG. 13A can be obtained by moving the cursor to the area 103 (of FIG. 4) explained above and clicking the area (or pressing the acknowledge button).

FIG. 13B shows an image obtained when the acknowledge button is pressed while the cursor is in a position as shown in, for example, FIG. 13A. The image shows an event list corresponding to a specified day. In addition, an event list of the day after the specified day can be shown. In this image, too, a name has been given to each of a plurality of areas as shown in FIG. 3B. They are broadly divided into a list area and an event preview area. The list area includes a daily separator and an area called an event item. The event item includes a “viewing reservation event,” a “recording reservation event,” and an “activity schedule event.” When the cursor is moved to the position of an event item, the user can see a preview of the event item in the event preview area.

FIG. 13C shows the details of an event. The image is displayed when an event item of FIG. 13B has been selected with the cursor and the acknowledge button has been pressed. The foremost image of FIG. 13C shows an example of the details of a “recording reservation event” being displayed. In the image, for example, the “title,” “broadcast type,” “broadcast time and date,” “media at a recording destination media,” and the like of a program reserved for recording are shown.

When the “Return” button in the image of FIG. 13C has been selected and the “acknowledge button” has been pressed, the image of FIG. 13B appears. When the “Return” button in the image of FIG. 13B has been selected and the “acknowledge button” has been pressed, the image of FIG. 13A appears.

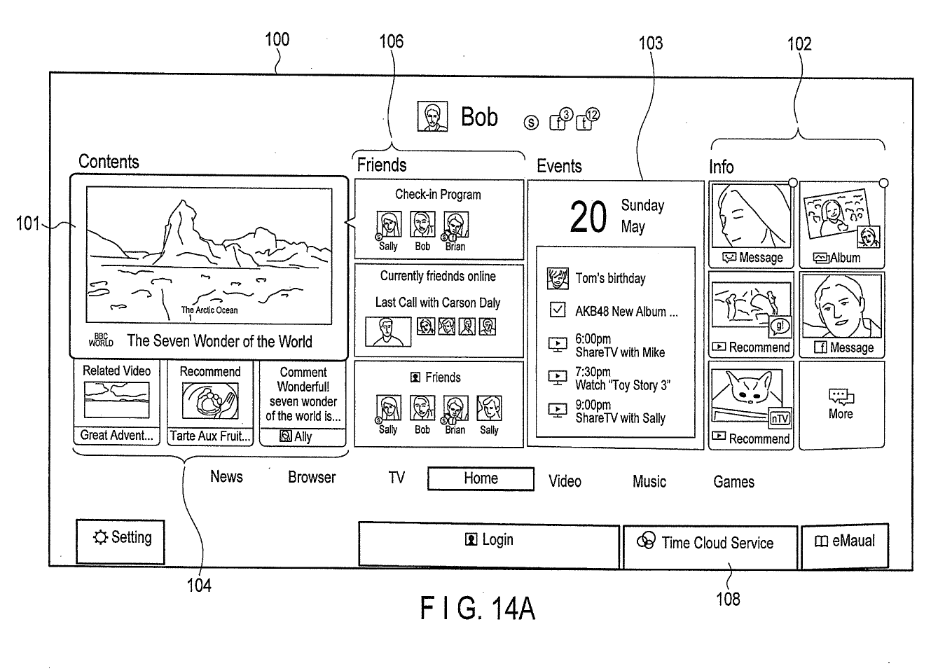

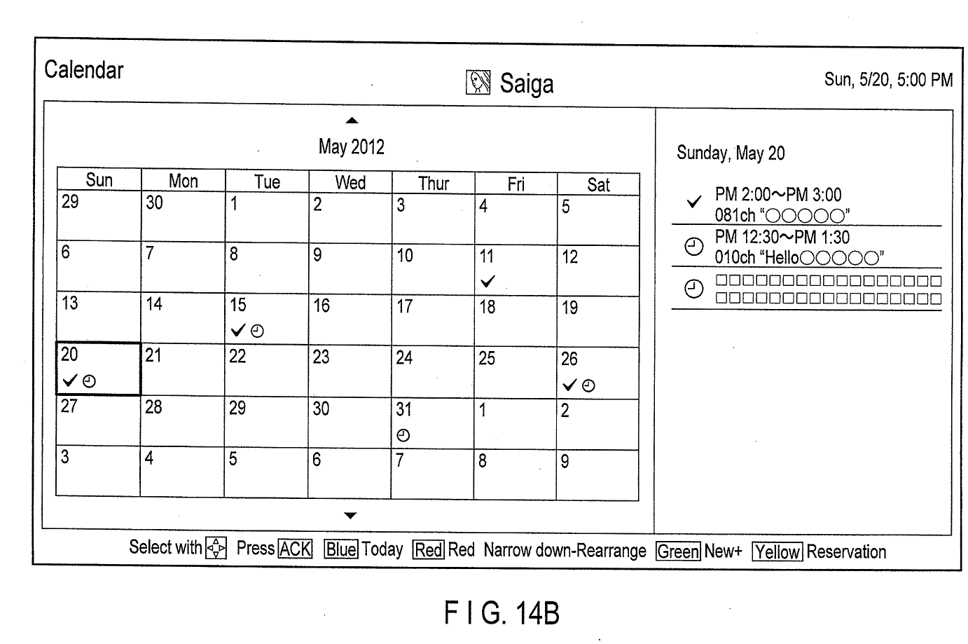

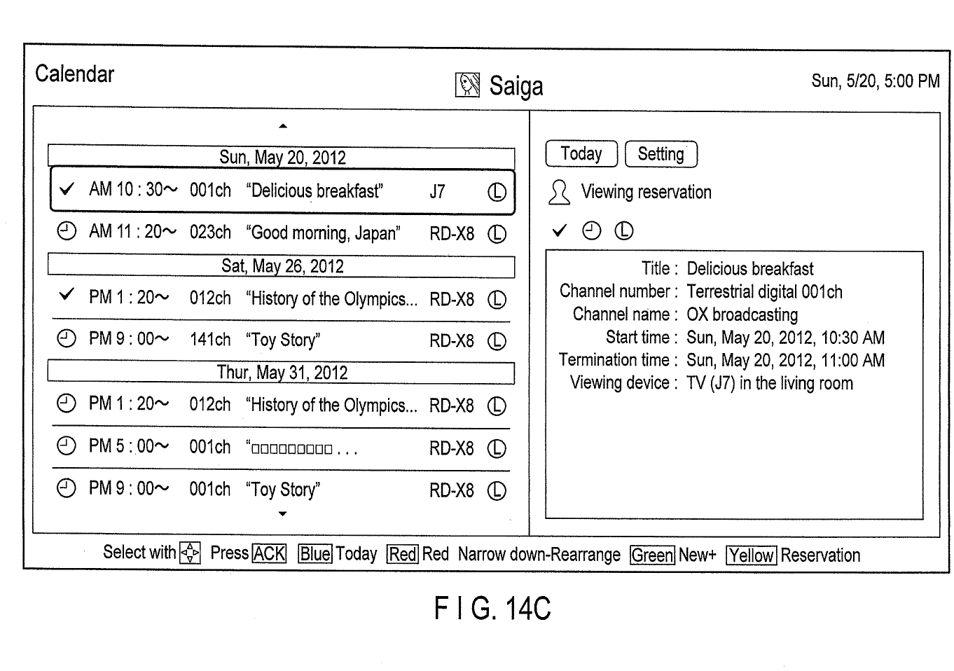

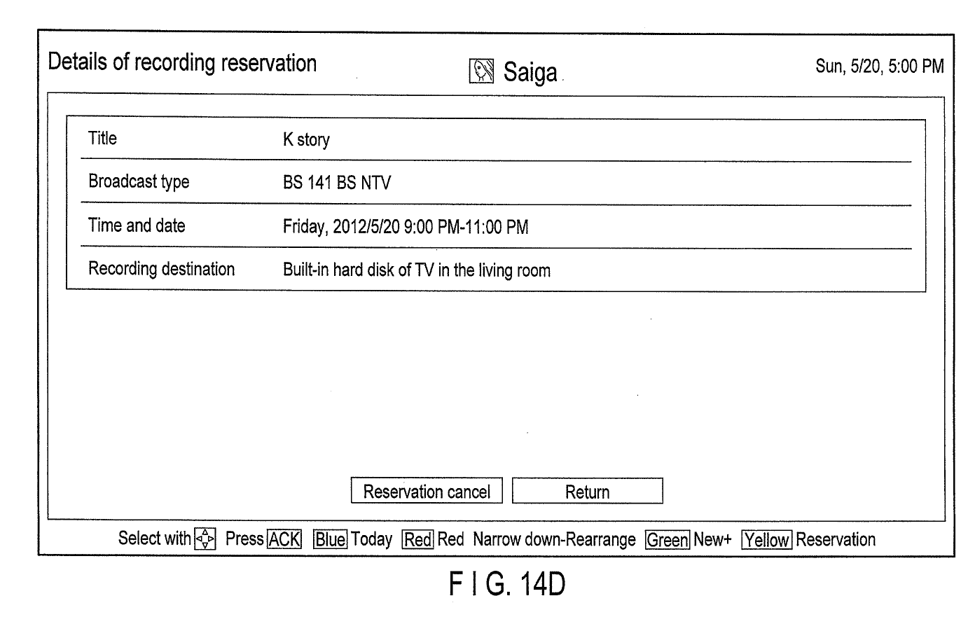

FIG. 14A to FIG. 14D show concrete images to explain the change of the aforementioned images. FIG. 14A, which is the same as FIG. 4, shows a home image. When the area 103 of FIG. 14A has been selected with the cursor and the “acknowledge button” has been operated, FIG. 14A goes into a state of FIG. 14B (corresponding to FIG. 13A). FIG. 14C and FIG. 14D correspond to FIG. 13B and FIG. 13C, respectively.

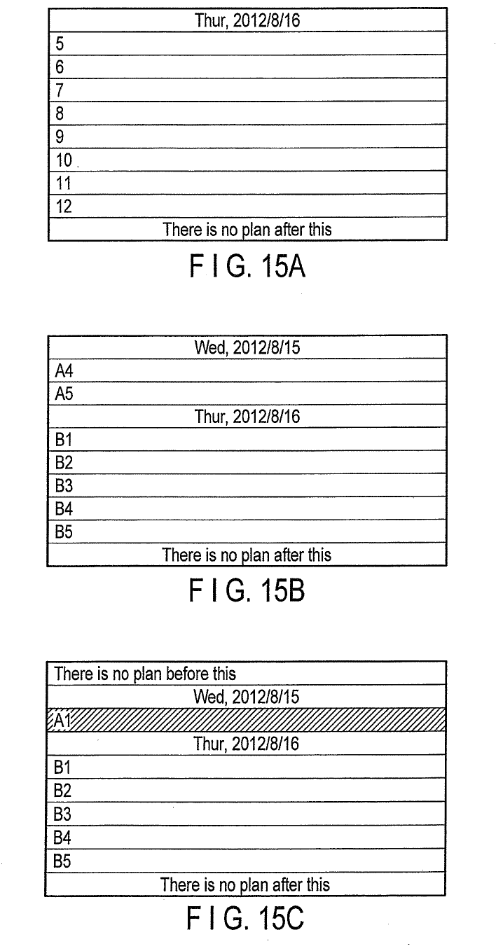

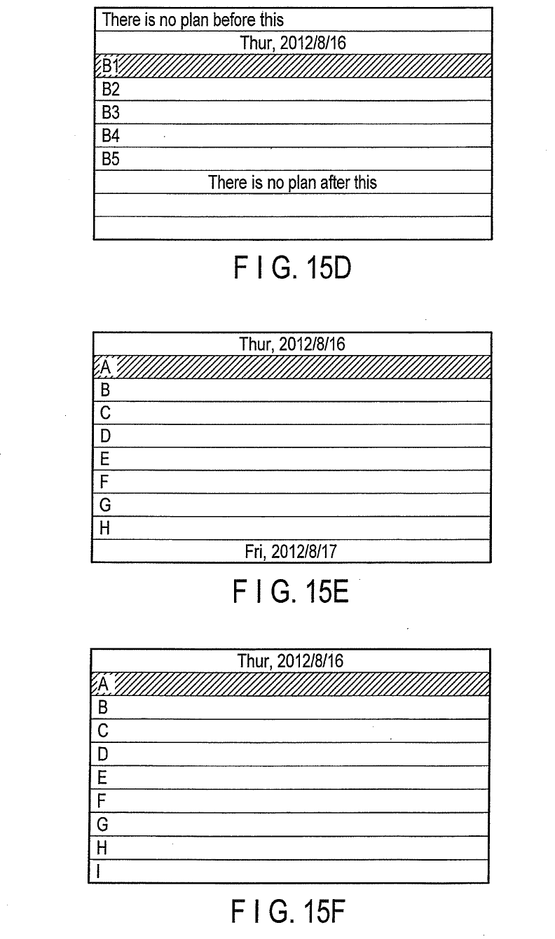

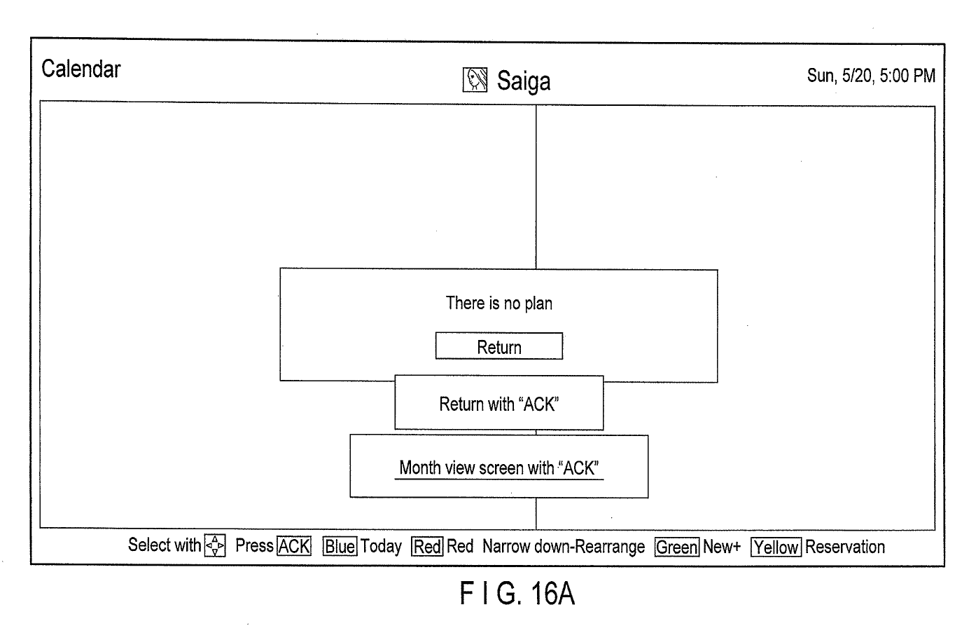

FIG. 15A to FIG. 15F are diagrams to explain the state of an image when a scroll controller has been operated at a view control module or a TV controller.

Hereinafter, a display method will be explained by classifying patterns according to the entry state of a reserved event on the assumption that the number of rows the list area can display is ten (including a daily separator). In addition, the maximum number of events that can be displayed is nine excluding a daily separator. If there is a message separator (for example, there is no plan after this”), the maximum number is set at eight.

FIG. 15A shows pattern 1. This example shows a case where 12 events (events 1 to 12) have been entered on August 16 and there is no reserved event on or after August 17. This state is obtained when a day on or after August 17 has been selected on a month view image and the image has transited to a list view image.

FIG. 15B shows pattern 2. This example shows a case where five events (events A1 to A5) have been entered on August 15, five events (events B1 to B5) have been entered on August 16, and there is no entered event on or after August 17. This state is obtained when a day on or after August 17 has been selected on a month view image and the image has transited to a list view image.

FIG. 15C shows pattern 3. This example shows a case where there is no entered event before August 14, one event (event A1) has been entered on August 15, five events (events B1 to B5) have been entered on August 16, and there is no entered event on or after August 17. This state is obtained when a day on or after August 17 has been selected on a month view image and the image has transited to a list view image.

FIG. 15D shows pattern 4. This example shows a case where there is no entered event before August 15, five events (events B1 to B5) have been entered on August 16, and there is no entered event on or after August 17. This state is obtained when a day on or after August 17 has been selected on a month view image and the image has transited to a list view image.

FIG. 15E shows pattern 5. This example shows a case where there is no entered event before August 15, eight events (events A to H) have been entered on August 16, and an event has been entered on August 17. This state is obtained when August 16 has been selected on a month view image and the image has transited to a list view image. As described above, there is a case where only a daily separator is displayed at the bottom of the list, depending on the number of reserved events to be displayed in the event list area.

FIG. 15F shows a case where, for example, today is August 16 and 12 events (events A to L) have been entered. Such an image is obtained when the “Today” button has been pressed. If there is no plan from today onward, the image will follow patterns 1 to 5.

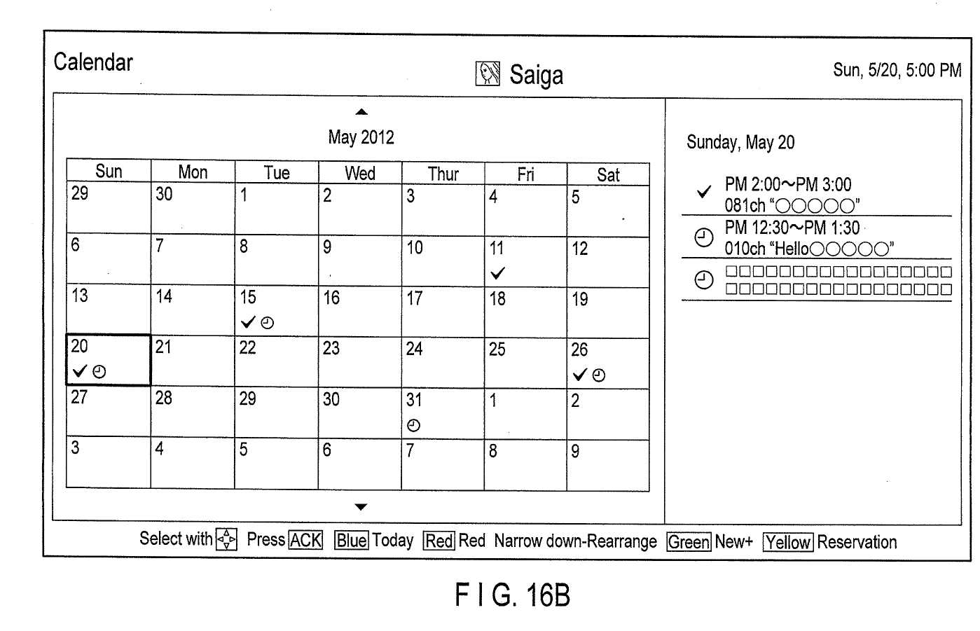

FIG. 16A shows an image displayed when no event has been entered on a month view image or when a certain day has been selected. In the image, the message dialog “There is no plan,” “Return with Acknowledge,” “Month view image with Acknowledge,” or the like appears.

As described above, the display of calendar-related information can be explained as follows. Each event item is delimited by a daily separator on a date basis. In this example, a focus is not located on the daily separator. When there is an event item, a daily separator is always displayed at the head of the list area. Following the daily separator, a summary of each event item of the day is displayed. The order in which event items are displayed is such that time gets older (in the past) as the position gets closer to the top of the list and time gets newer (in the future) as the position gets closer to the bottom of the list. When a focus is located on an event item, event detailed information is displayed in the event preview area. The order in which event items are displayed can be filtered or sorted according to conditions.

Next, the scrolling of a list of event items can be explained as follows. A list display can be scrolled continuously over information on more than one day, not over information on one day. A focus in a list display can be moved with cursor-up and cursor-down keys (upward arrow and downward arrow). However, a focus is not located on a daily separator. When an upper-lower page button is operated, the display is changed by one page (not by one item) and a focus is located on a first item. When the cursor-up key (upward arrow) has been pressed at the upper end of the list, the display is changed by one page (not by one item) and the focus is located on the last item. When the cursor-down key (downward arrow) has been pressed at the lower end of the list, the display is changed by one page (not by one item) and the focus is located on a first item.

The focus moves between the list area and the function button as follows. When the cursor-left key (leftward arrow) has been pressed while the focus is located on an event item, the focus moves to the “Today” button. When the cursor-right key (rightward arrow) has been pressed while the focus is located on the “Today” button, the focus moves to an event item. The focus does not move between the list area and the event preview area with the cursor-right and cursor-left keys (rightward arrow and leftward arrow). The focus may not be moved cyclically with the cursor-right and cursor-left keys.

The method of switching between the list view state and month view state of the calendar is not limited to the above embodiment. For example, there may be a method of switching from the list view state to the month view state by locating a focus on the part of the daily separator with the cursor and pressing the acknowledge button. In addition, the switching of the view state from the month view state to the list view state is performed by selecting one block in a calendar in the month view state and pressing the acknowledge button.

The view state of the calendar can be changed by a scroll function explained below.

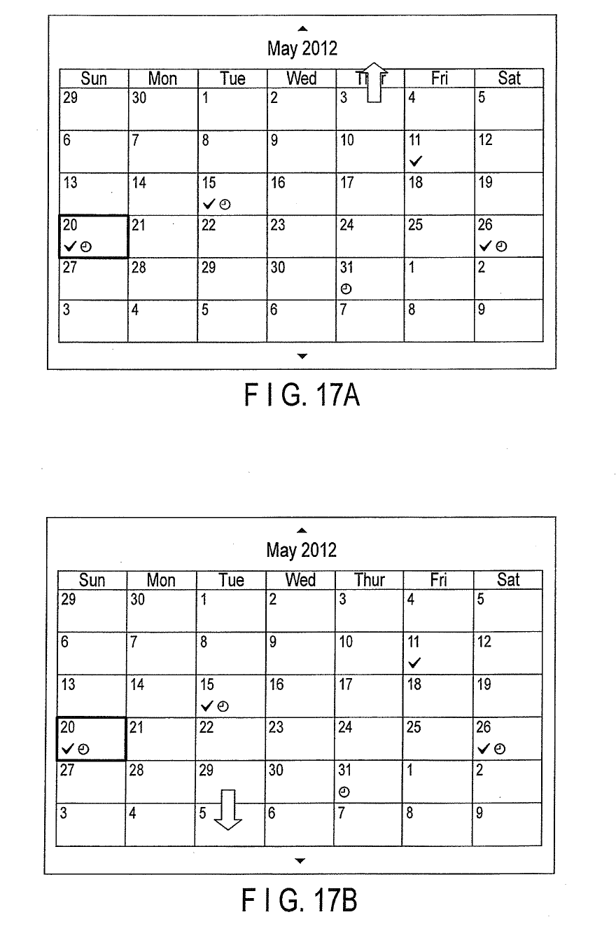

As shown in FIG. 17A, for example, with a focus located on May 3 (Thu), when the cursor-up key (upward arrow) on the remote controller has been pressed, an April page of the calendar can be displayed, thereby locating a focus on April 26 (Thu) (the same day [Thu] of the last week).

As shown in FIG. 17B, for example, with a focus located on May 29 (Tue), when the cursor-down key (downward arrow) on the remote controller has been pressed, a June page of the calendar can be displayed, thereby locating a focus on June 5 (Tue) (the same day [Tue] of the first week).

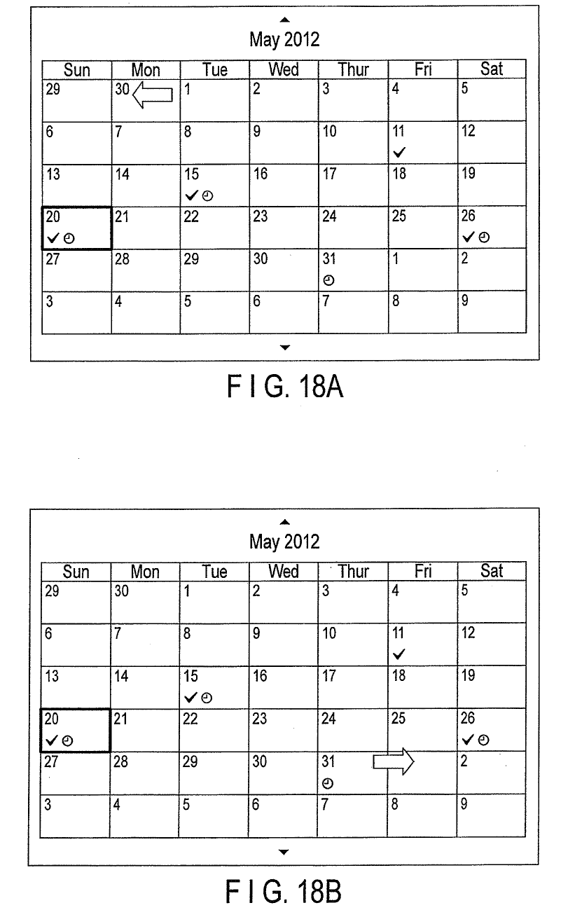

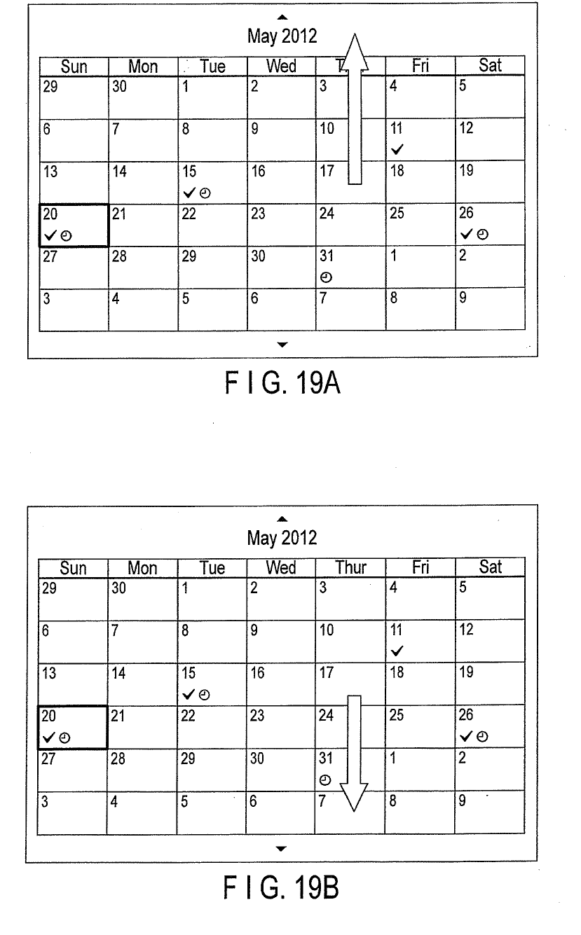

As shown in FIG. 18A, for example, with a focus located on May 1 (Tue), when the cursor-left key (leftward arrow) has been pressed, an April page of the calendar can be displayed, thereby locating a focus on April 30 (Mon) (the last day of the month).

As shown in FIG. 18B, for example, with a focus located on May 31 (Thu), when the cursor-right key (rightward arrow) has been pressed, a June page of the calendar can be displayed, thereby locating a focus on June 1 (Fri) (the first day of the month).

As shown in FIG. 19A, for example, with a focus located on May 17 (Thu), when the upper page button has been pressed, an April page of the calendar can be displayed, thereby locating a focus on April 17 (Tue) (the same day in May).

As shown in FIG. 19B, for example, with a focus located on May 17 (Thu), when the lower page button has been pressed, a June page of the calendar can be displayed, thereby locating a focus on June 17 (Sun) (the same day in May).

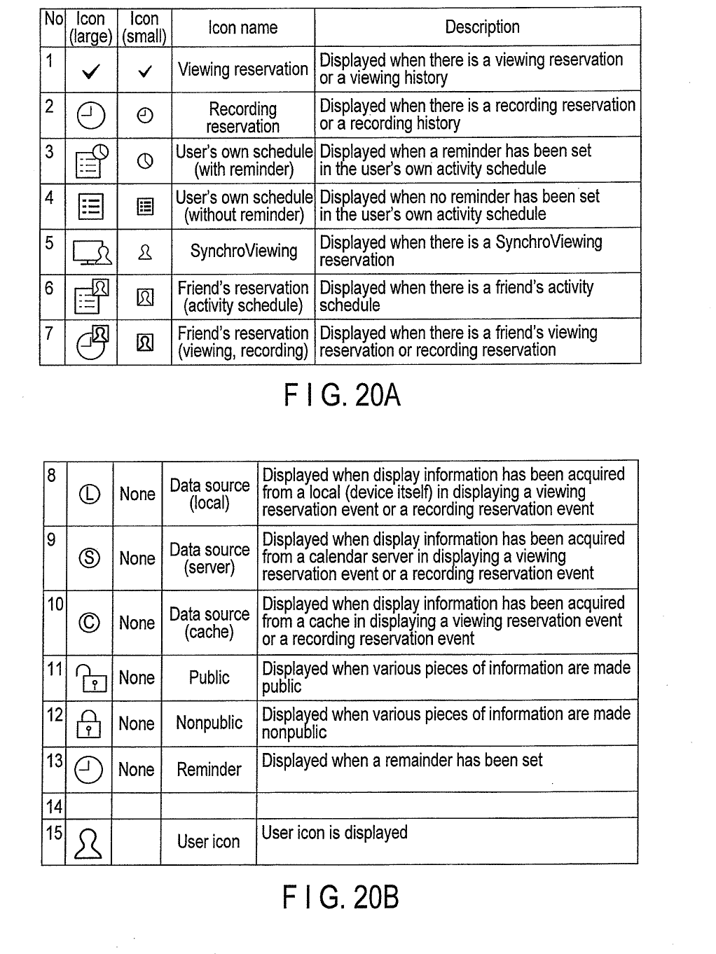

FIGS. 20A and 20B show the names of various icons displayed in the image of the calendar and their meanings. Icons displayed in the calendar enable the user to recognize events of the day immediately.

The icons are not restricted to the ones shown in FIGS. 20A and 20B. Other various types of icons may be added. For example, a mark representing a school timetable (textbook) may appear in the form of an icon. In addition, the user may be allowed to select and set an arbitrary icon. In this case, a wide variety of icons have been stored in a memory, enabling the user to select a desired one.

Information in the calendar, such as an activity schedule, can be edited (i.e., modified, added, moved, or deleted) in an edit mode.

In the month view state or list view state of the calendar, information on the recording reservation, recording history, viewing reservation, viewing history, or the like can be used.

Furthermore, it is possible to transit from the month view state or list view state of the calendar to a preview of programs included in the viewing history or recording history, the reproduction of a scene list, or the reproduction of tags. Specifically, in the month view state of the calendar, the cursor can be moved to a desired day to locate a focus on the day, enabling a viewing history button or a recording history button on the remote controller to be operated. When the viewing history button or recording history button has been operated, a list of programs viewed on the corresponding day or a list of programs recorded the corresponding day can be displayed. At this time, when the cursor is moved to a desired program name to locate a focus on the name, a preview display of the corresponding program can be obtained.

Moreover, in the month view state or list view state of the calendar, a recording reservation or a viewing reservation can be confirmed.

The apparatus can combine additional information on its own calendar with that on another person's calendar. A calendar to which additional information has been added may be called an information calendar or a control calendar.

The apparatus can check another person's recording reservation information or view reservation information or take in the information as additional information for its own calendar. Another person's recording reservation information or view reservation information is information added to, for example, another person's calendar.

In addition, another person's recording reservation information or view reservation information may be recording reservation information or view reservation information in a calendar or a database managed by another person or by another device.

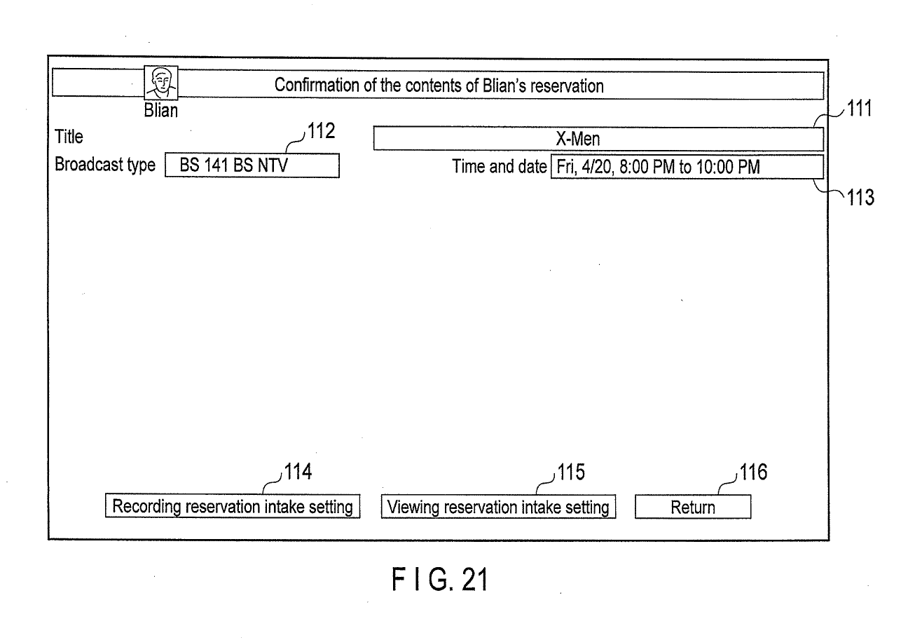

FIG. 21 shows an image when recording reservation information and viewing reservation information are taken into the user's own calendar. This image appears when, for example, the “Another person's reservation information” button has been clicked in, for example, the list view state on a desired date in a calendar. The example of FIG. 21 shows a case where the contents of another person's (Brian's) reservation are displayed. When this area is selected with the cursor and, for example, the “Next key” is operated, still another person's reservation information can be displayed.

In the image, the title of a program and a broadcast form (broadcast type) are displayed in the area 111 and area 112, respectively. In addition, the time and date that a program was broadcast are displayed in the area 113, a button that specifies whether to take in recording reservation information is displayed in the area 114, and a button that specifies whether to take in viewing reservation information is displayed in the area 115. A return button is displayed in the area 116. When the return button has been selected and the acknowledge button has been pressed, the image transits to the preceding list view state. When the area 112 has been selected with the cursor and, for example, the “Next key” has been selected, the status of another program's reservation can be checked.

Either the area 114 or area 115 can be selected with the cursor and the unselected area goes into a state where the brightness is lower. In the example of FIG. 21, suppose the area 114 can be selected with the cursor. In this case, the area 114 is selected and the acknowledge button is pressed, thereby enabling a program another person (Brian) has reserved for recording to be taken into as an event for the user's own calendar. In the example of FIG. 21, suppose the area 115 can be selected with the cursor. In this case, the area 115 is selected the acknowledge button is pressed, thereby enabling a program another person (Brian) has reserved for viewing to be taken into as an event for the user's own calendar.

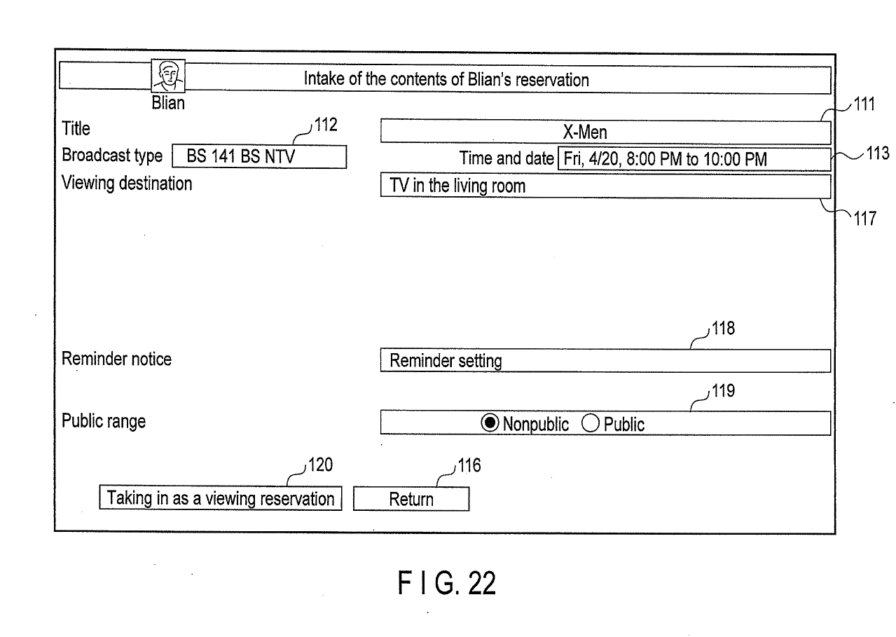

The buttons of the areas 114, 115 in the image of FIG. 21 may be used to move to a subsequent image. For example, when the area 115 has been selected with the cursor and the acknowledge button has been pressed, the image may transit to an image in FIG. 22, thereby taking in actual reservation information. In the image of FIG. 22, the button reading “Take in as a viewing reservation” is displayed. When the area 114 has been selected with the cursor in FIG. 21 and the acknowledge button has been pressed, the button reading “Take in as a recording reservation” is displayed in the area 120 in the image of FIG. 22.

Furthermore, in the image of FIG. 22, a viewing destination device can be specified in the area 117. That is, a TV apparatus connected to a network may be installed in a living room, a kitchen, or a bedroom in a house. Therefore, a viewing place and a viewing time can be specified. The image of FIG. 22 shows that the viewing of a program specified for the time specified by the TV apparatus in the living room is to be started.

The example shows the image when information for a viewing reservation is taken in. The apparatus is not limited to such a case. The apparatus has been configured to be capable of specifying a viewing place when a viewing reservation has been made.

Still furthermore, whether to give a reminder can be set in the area 118. As a reminder, for example, the message “A viewing reservation for program AAA has been set” is displayed in the lower part of the image when the time has reached, for example, three minutes before the playback time of a specified program.

The example has shown the way information on the recording reservation, recording history, viewing reservation, viewing history, or the like can be used on the TV apparatus the user is using, or on another TV apparatus or a recording device in the user's house. This TV apparatus can communicate with a cloud service server. Therefore, information on the recording reservation, recording history, viewing reservation, viewing history, or the like uploaded to the cloud service server and released to the public can be downloaded to and used on the TV apparatus.

In this case, program information has to be processed into the one the user can use. The reason the processing is done is that a broadcast may differ in broadcast channel, broadcast time slot, or the like from region to region. Therefore, program information (for example, broadcast channel or broadcast time slot) on the recording reservation, recording history, viewing reservation, and viewing history created on another person's TV apparatus has to be processed and used. Such processing is referred to as “channel allocation.”

The following two ways of allocating channels are available. Either one may be employed.

(a1) Channel allocation is performed before information on another person's viewing reservation or recording reservation is displayed. In the image of FIG. 21 or 22, the already allocated broadcasting station name, time slot, and the like are displayed.

(a2) In the image of FIG. 21 or 22, information on another person's viewing reservation or recording reservation before channel allocation is displayed. Then, at the time when a reservation taking-in operation is actually performed, channel allocation is performed and added to a calendar.

As described above, this apparatus can relate to information on another person's viewing reservation, recording reservation, and the like with the user's own calendar.

The mode of correlating information with the calendar includes the following modes:

(b1) the mode of correlating information with the calendar in the apparatus the user is using

(b2) the mode of correlating information with the calendar between the apparatus the user is using and another apparatus in the user's house

(b3) the mode of correlating information with the calendar between the apparatus the user is using and a cloud service server

Here, the priority order of the calendar processing modes is considered. When information is related to a calendar, the mode of correlating information with a calendar is given priority in the apparatus the user is using in (b1). In the apparatus, each of recording reservation information, viewing reservation information, recording history information, and viewing history information can be managed by each member of the family. Each member of the family can set the pieces of managed information public or nonpublic. In addition, the pieces of managed information can be managed as public information on all the member of the family. This is because data items, including the recording reservation, recording history, viewing reservation, and viewing history, are managed according to family and individual login identifiers at the management module. When information is related to a calendar in the apparatus the user is using, the channel allocation process and the like are not needed.

The mode given a second order of priority is the mode of correlating information with a calendar between the apparatus the user is using and another apparatus in the house written in (b2). In this case, too, the channel allocation process and the like are not needed.

The mode given a third order of priority is the mode of correlating information with a calendar between the apparatus the user is using and a cloud service server. This mode is effective when the user has mistakenly deleted viewing reservation information (or recording reservation information) in the apparatus the user is using. The viewing reservation information (or recording reservation information) has particularly taken in from an external device and, if the user has deleted the information by mistake, the user cannot restore the viewing reservation information (or recording reservation information) in the apparatus the user is using.

In such a case, the information may remain in the cloud service server. It is convenient if the user acquires the viewing reservation information (or recording reservation information) from the cloud service server.

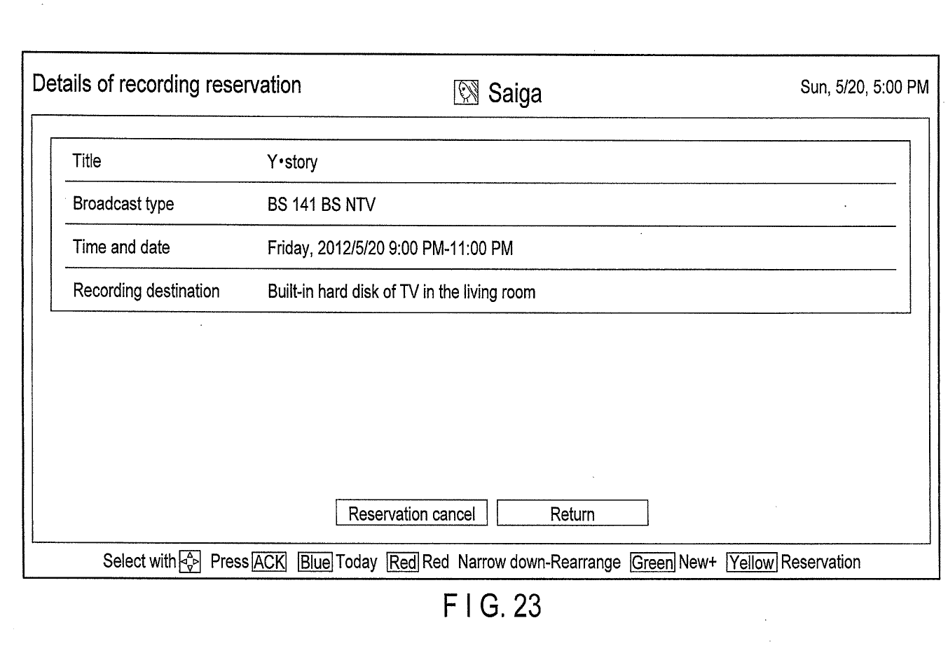

FIG. 23 shows an example of an image when a viewing reservation (or a recording reservation) is cancelled. The image of FIG. 23 has shown in detail the transition from the image of FIG. 13B to that of FIG. 13C explained above. In the image, detailed information on a program reserved for viewing is displayed. In addition, the “Reservation cancel” button is displayed. When wanting to cancel a viewing reservation for a program reserved for viewing, the user selects the “Reservation cancel” button with the cursor and presses the acknowledge button, thereby cancelling the viewing reservation for the program. A recording reservation can be cancelled in a similar manner.

In the modes explained in (b1), (b2), and (b3), the transition to viewing reservation information (or recording reservation information) can be performed in a preview state.

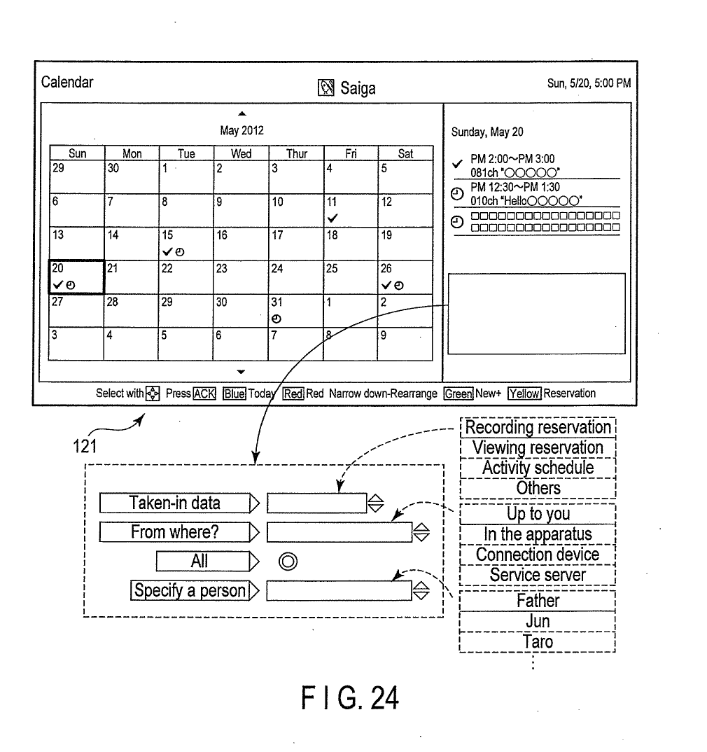

For example, as shown in FIG. 24, when the “New” button 121 has been selected and the acknowledge button has been pressed, a correlation process setting image appears. The example of FIG. 24 has shown that, on May 20 in another person's public calendar, reservation information that describes an event (a recording reservation or a viewing reservation) is to be taken in. In the setting image, there is a button used to determine to which of “a recording reservation,” “a viewing reservation,” “an activity schedule,” and “Others” the taken-in data is set. With the cursor-up and cursor-down keys, “Recording reservation,” “Viewing reservation,” “Activity schedule,” or “Others” can be specified.

Moreover, there is a button used to specify from where reserved data is taken in. With the cursor-up and cursor-down keys, “Up to you,” “The apparatus,” “The connection device,” or “the service server” can be specified. With a viewing reservation being set, when “Up to you” has been set, the modes explained in (b1) . . . “in the apparatus,” (b2) . . . “the connection device,” and (b3) . . . “the service server” are performed sequentially. When the loading of reserved data from “the apparatus” has been completed, the message “The loading of reserved data from the apparatus has been completed. Do you want to continue?” is displayed. When the loading of reserved data from “the connection device” has been completed, the message “The loading of reserved data from the “connection device” has been completed. Do you want to continue?” is displayed. The user can operate the acknowledge button, thereby giving an instruction to continue the operation. The user can operate the end button, thereby giving an instruction to terminate the operation. When the loading of reserved data from “the service server” has been completed, the message “The work of loading reservation information has been completed” is displayed.

In addition, it is possible to set whether to load reservation information on all the people for the selected “day” or to load reservation information on a specified person. Therefore, a button to specify all the people and a button to specify a person are prepared.

As described above, with the apparatus, additional information can be added to a calendar, thereby making the calendar multifunctional to produce an information calendar. In addition, the information calendar can be upgraded. When additional information is added to the calendar, if there are overlapping pieces of additional information, the one in the calendar of the user currently operating the TV apparatus is given top priority. Additional information given the second highest priority is the one in another person's calendar stored in the TV apparatus. Additional information given the lowest priority is the one from the cloud service server.

With the apparatus, the user can set, for example, the entire calendar public or nonpublic. Therefore, another person cannot take in reservation information on a certain person's nonpublic calendar. Each piece of reservation information may be set public or nonpublic. Furthermore, when a calendar is made a public one, a public range may be set.

For example, in the image shown in FIG. 22, buttons to set public and nonpublic are provided in the area 119. When the public button is marked, the reservation information becomes public. When the nonpublic button is marked, the reservation information becomes nonpublic. FIG. 24 shows the way reservation information to be taken into can be made public or nonpublic. Alternatively, a setting image that makes it possible to determine whether additional information on the entire calendar is made public or nonpublic, a setting image that makes it possible to determine whether a part of additional information on the calendar is made public or nonpublic, a setting image that makes it possible to determine whether additional information on the calendar is made public or nonpublic according to the classification of additional information can be prepared. Moreover, a setting image that sets a public range may be prepared. The public range may be made public in a range of devices and apparatuses connected to a home LAN or in a range of specified devices and apparatuses.

In making information public or nonpublic, the following rule has been set. Nonpublic setting cannot be performed on common data (including recording reservation data, viewing reservation data, and calendar) in a common domain that enables common login in an apparatus shared by all the members of the family.

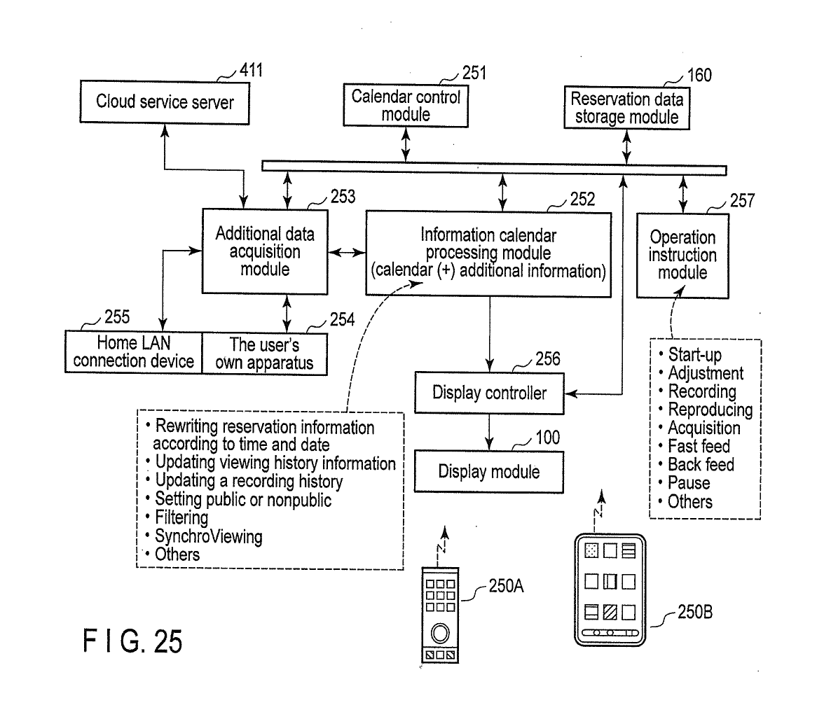

FIG. 25 selectively shows a block configuration that processes the calendar and creates an information calendar. These blocks are such that the blocks related to a calendar process have been extracted from the TV apparatus shown in each of FIGS. 5 and 12.

A calendar is processed under the control of a calendar control module 251. An information calendar processing module 252 can take in viewing reservation information and recording reservation information from an additional information acquisition module 253. The user's calendar in a login state is set in the information calendar processing module 252. The additional information acquisition module 253 can acquire another calendar in the apparatus itself, a calendar in another apparatus 255 connected to a home LAN, and a calendar stored in a cloud service server 411. The information calendar processing module 252 can combine the user's calendar in the login state with information on another calendar (in the process of taking in recording reservation information and viewing reservation information explained above).

The information calendar in the information calendar processing module 252 can be displayed on the display module 100 via a display controller 256. The display controller may be called an information calendar output module or a display processor. Display states of an information calendar include the various ones explained above.

Additional information on an information calendar has been ascertained by the calendar control module 251. Therefore, according to the operation of a remote controller 250A or a mobile terminal 250B, the calendar control module 251 controls an operation instruction module 257 to perform the switching between display modes, scrolling, the loading of reservation information, and the like as described above. In addition, when the start time of a recording reservation or a viewing reservation has been reached, the calendar control module 251 sends a command to the operation instruction module 257. On the basis of the command, the operation instruction module 257 can cause the TV apparatus to start an operation, such as recording or reproducing. In addition, when an event item has been selected with the cursor and the acknowledge button has been pressed, the calendar control module 251 can start the operation of displaying the details of the corresponding event item.

The recording reservation data and viewing reservation data have been stored as additional information in a reservation data storage module 160. The reservation data storage module 160 can further store various data items (including events and activity schedules) related to the calendar. The TV apparatus, which has a recording reservation function and a viewing reservation function, creates recording reservation data and viewing reservation data. These are managed by the controller of FIG. 12 on a user basis and on a household basis. A recording reservation is made on the basis of a program table created from an electronic program guide (EPG). A past recording history program table is created from canned program information recorded in an HDD. A viewing reservation is made on the basis of the recording history program table. The user's information calendar in the login state is created at an information calendar processing module 252 making use of reservation data stored in the reservation data storage module 160.

In the explanation, the “processing modules,” “acquisition modules,” “modules,” and the like have been used. They may be represented as the “processing means,” “acquisition means,” “means,” and the like or as the “processing blocks,” “acquisition blocks,” “blocks,” and the like.

The principal blocks of FIG. 25 include a storage module (for example, a reservation data storage module) that stores first additional information to be related to a first calendar (for example, the user's own calendar logged in), an information acquisition module (for example, an additional information acquisition module 253) that can acquire second additional information to be related to a second calendar (for example, a calendar of a member of the family or a friend) from another electronic device, an output module (for example, the display controller 256 and an information calendar processing module 252) that relates to the first additional information and the second additional information with the first calendar and outputs the resulting information, and a control module (a calendar control module 251 and an operation instruction module 257) that performs processing based on a user operation on the second additional information of the first calendar.

FIG. 25 shows a block configuration. In the system of each of FIGS. 5 and 12, the block configuration of FIG. 25 can be realized using software (programs). A recording medium (for example, a semiconductor memory, a magnetic disk, or an optical disk) that has stored the software (programs) enables the transition and change of various images explained in the specification to be realized using display software. The way the user gives an operation instruction is not limited to the methods described in the specification. Various realization methods may be employed.

One of the embodiments described above also has a characteristic of a method. Specifically, a calendar information processing method is to acquire additional information to be related to a calendar and create an information calendar that relates to the additional information with the calendar. The method is further to output the information calendar to display the information calendar and give an instruction to operate on the basis of the additional information of the information calendar.

According to one of the embodiments, the concept of a program that controls a computer is also included in the scope of the embodiment. Specifically, the embodiment includes a command to acquire additional information to be related to a calendar and a command to create an information calendar that relates to the additional information with the calendar. The embodiment further includes a command to output the information calendar to display the information calendar and a command to give an instruction to operate on the basis of the additional information of the information calendar. In addition, an information recording medium that has stored the program that controls a computer is also in the scope of the embodiment.

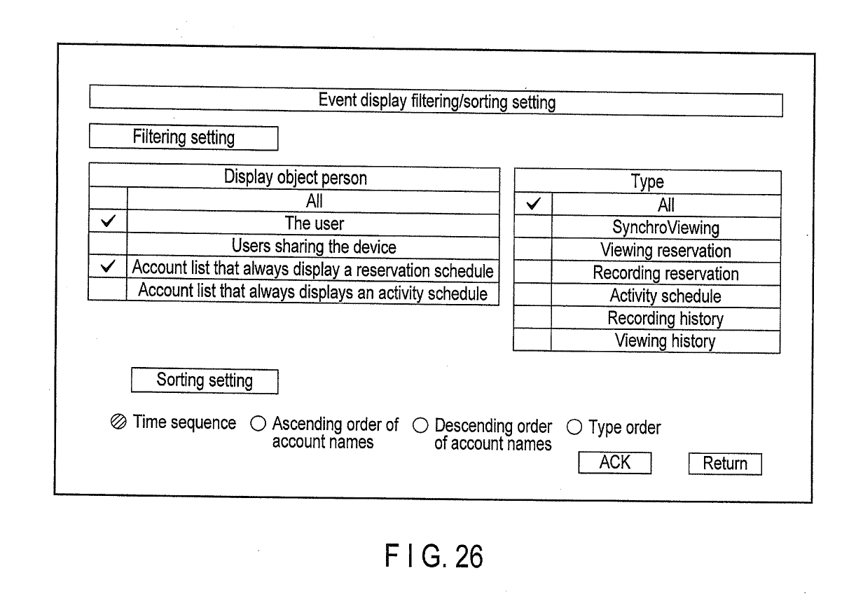

FIG. 26 shows an example of an image when filtering is set. As described above, the apparatus can take in information on many events or refer to information on many events. When there are many events, it takes time to check the events. Therefore, the apparatus can filter events and change the display order.

For example, operating a red key on the remote controller enables the transition from the image shown in each of FIGS. 23 and 24 to the image in FIG. 26. As in the image of FIG. 26, an event object person (display object person) displayed in an event item can be set. In the above explanation (FIGS. 13A and 13B), events entered in the user's own calendar are supposed to be displayed. However, with the apparatus, when there are a public calendar and public events, public events can be displayed as shown in FIG. 13B by setting a display object person.

In the example of FIG. 26, a setting image for setting a display object person is arranged in the right-side area. In this example, a check mark is written in the user's own checkbox and in a checkbox for a person allowed to always display a reservation schedule (including a viewing reservation and a recording reservation). The other display object persons include users who share a device and a user allowed to always display an activity schedule. Moreover, in the example of FIG. 26, a setting image for setting the types of events is arranged in the right-side area. In this example, to display all the events, checkmarks are written. The types include SynchroViewing, viewing reservation, recording reservation, activity schedule, recording history, and viewing history.

Furthermore, in the lower part of the image of FIG. 26, there are buttons for selecting any one of time sequence, ascending order of accounts, descending order of accounts, and type order when sorting is performed. In the example, time sequence has been selected, causing events to be sorted so that they are arranged in time sequence. When the acknowledge button has been pressed, sorting is performed according to a set filter. This enables events to be displayed in the order and items according to the user's liking.

The apparatus has a SynchroViewing function. The SynchroViewing function is the function of enabling the user to offer more than one friend or relative of the user's at remote locations to view the same program at the same time when the user wants to.

Programs or contents to be viewed at the same time include, for example, on-air programs, canned programs, and video on demand. In the case of on-air programs, the broadcast time slot must be the same in the living areas of the friends or relatives.

As explained above, this system enables the user to communicate with the friends or relatives at remote locations. Moreover, as shown in FIG. 4, the user can check a friend in the login state.

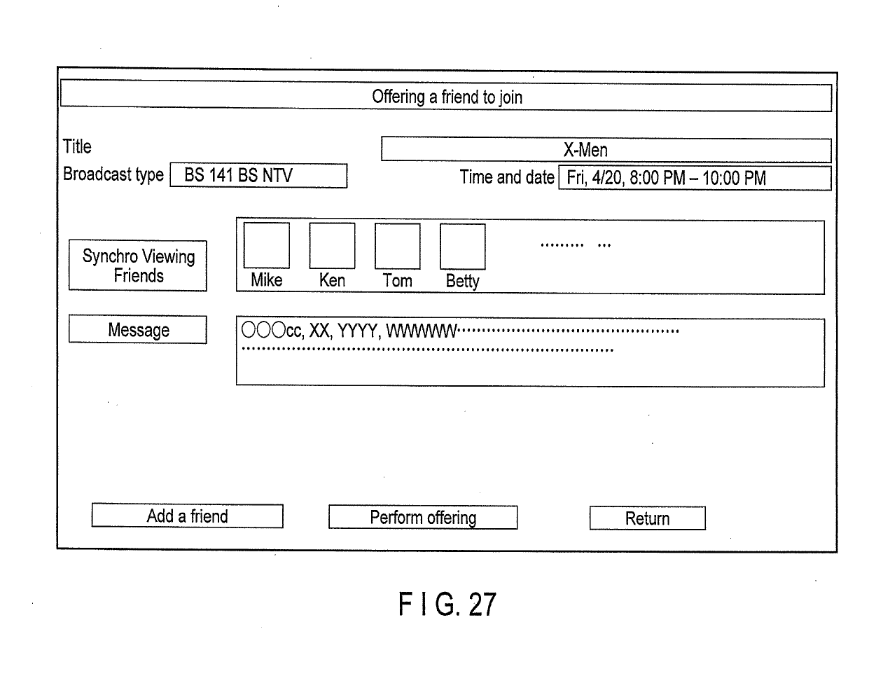

FIG. 27 shows an example of an image used when the user offers a friend of the user's to join SynchroViewing. This image can be displayed by operating, for example, a SynchroViewing key on the remote controller. Alternatively, a SynchroViewing setting button is provided on an event detail screen (for example, FIGS. 13, 14D, and 23). The SynchroViewing setting button is selected and the acknowledge button is pressed, thereby enabling the image of FIG. 27 to be displayed.

As shown in FIG. 27, in the upper part of the image, the title of the image, “Offering a friend to join”, is displayed. In addition, the title, broadcast type, and broadcast time and date of “a program” the owner wants to view together with participants at the same time are displayed.

In the lower part of the image, the “Add a friend” button for adding a friend, the “Perform offering” button, and the “Return” button are displayed. When the “Add a friend” button has been selected and the acknowledge button has been pressed, a face image (or an icon or an avatar) of the first friend entered in a management device and the friend's name are displayed in a SynchroViewing Friends field. In this state, when the acknowledge button has been pressed, the face image and name remain and the friend is set as a participant. However, when the “Next key” has been operated with the face image and name of the first friend being displayed, the face image and name of the next friend appear. In this situation, when the acknowledge button has been pressed, the face image and name of the next friend remain and the next friend is set as a participant. With the participant being set in this way, when the cursor has been moved to the position of a message, a message can be input. As described above, a friend is selected from an account list entered in the management device.

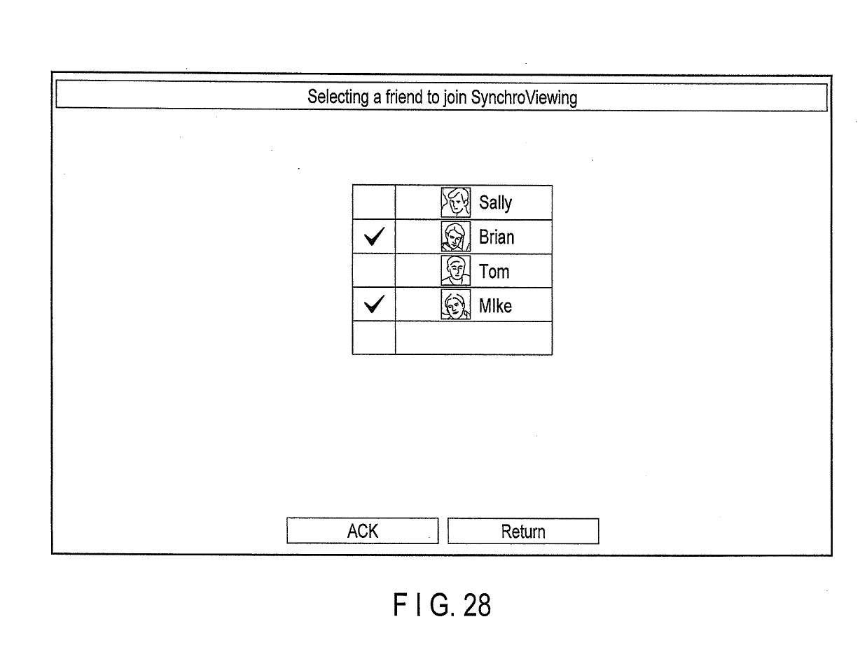

FIG. 28 shows another embodiment when the owner specifies a friend for SynchroViewing. For example, when the owner has selected the “Add a friend” button and pressed the acknowledge button, an image in FIG. 28 may appear. In the image, a face image of a friend previously entered in the management device and the friend's name are displayed. The owner can specify a friend who is to join SynchroViewing by writing a check in a checkbox corresponding to a desired friend. Next, when the owner has operated the “Return” button, the image returns to the image of FIG. 17, enabling the owner to enter a message here.

After having input the message, the user (owner) moves the cursor to the “Perform offering” button and presses the acknowledge button, causing the message to be transmitted to each friend. A friend who has received the offer will open the in-box, read the message, and transmit a return message. In this case, the return message includes an “approval” or “reservation” reply at the head or in a specific position of the message. “Approval” means that SynchroViewing is to be performed. “Reservation” means that it is uncertain whether SynchroViewing is to be performed. The TV apparatus of the friend who has received the offer automatically makes a viewing reservation for a program for SynchroViewing or displays an image for making a viewing reservation. At this time, channel “allocation” as explained above is performed as needed.

With the owner's TV apparatus, for example, in the image of area 104 explained in FIG. 4, the face images (or icons) of all the friends offered to join SynchroViewing can be seen. However, on the TV apparatus of a friend offered to join, only the face images (or icons) of people joining SynchroViewing can be seen.

When, for example, a fast-feed, a pause, or a back-feed button has been operated with a canned program or video on demand on the owner's TV apparatus, the SynchroViewing function enables similar fast feeding, pausing, or back feeding to be performed also on the participant's TV apparatus. This is because control information on the owner's TV apparatus is transmitted to the TV apparatuses of the participants via the cloud service server in the SynchroViewing operation state.

When the SynchroViewing function is used, a time-shift function is used. The time-shift function can record all the programs on a plurality of channels (for example, six channels) simultaneously for, for example, about one to three weeks and record them in an HDD. The user can refer to viewing reservation data, select a desired program, and reproduce the selected program by operating the TV apparatus. Use of the time-shift function enables the user to enjoy SynchroViewing together with many participants and increase the number of programs enabling SynchroViewing.

As for SynchroViewing of on-air broadcasts, the owner may select participants arbitrarily or a friend offered to join may reject the participation. The reason is that an on-air broadcast differs in time slot from region to region.

The TV apparatus, which has a near-field communication function as explained in FIG. 12, can communicate with a mobile terminal (for example, a tablet).

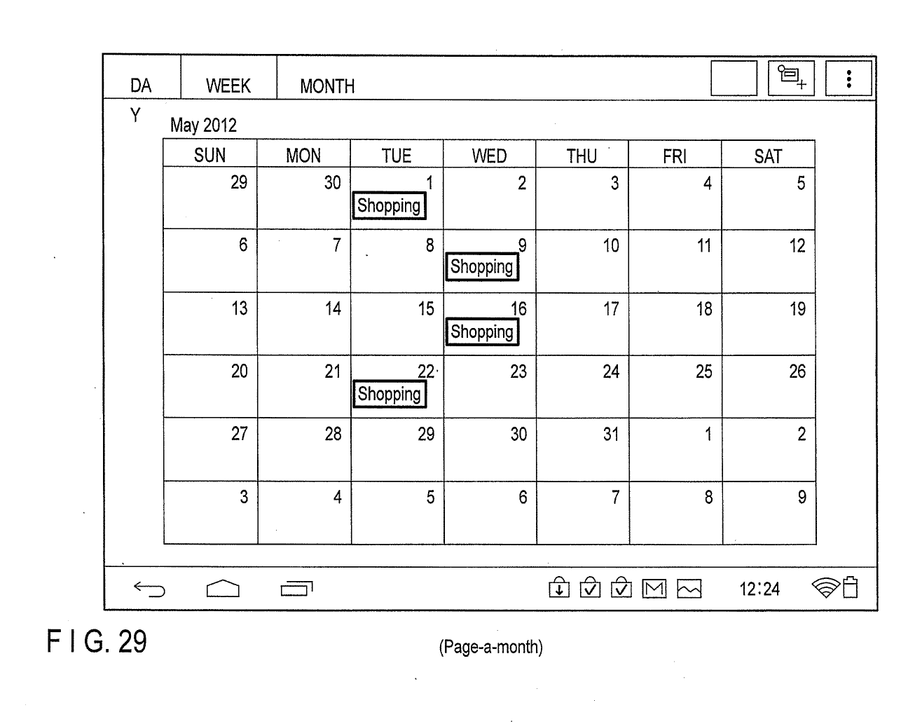

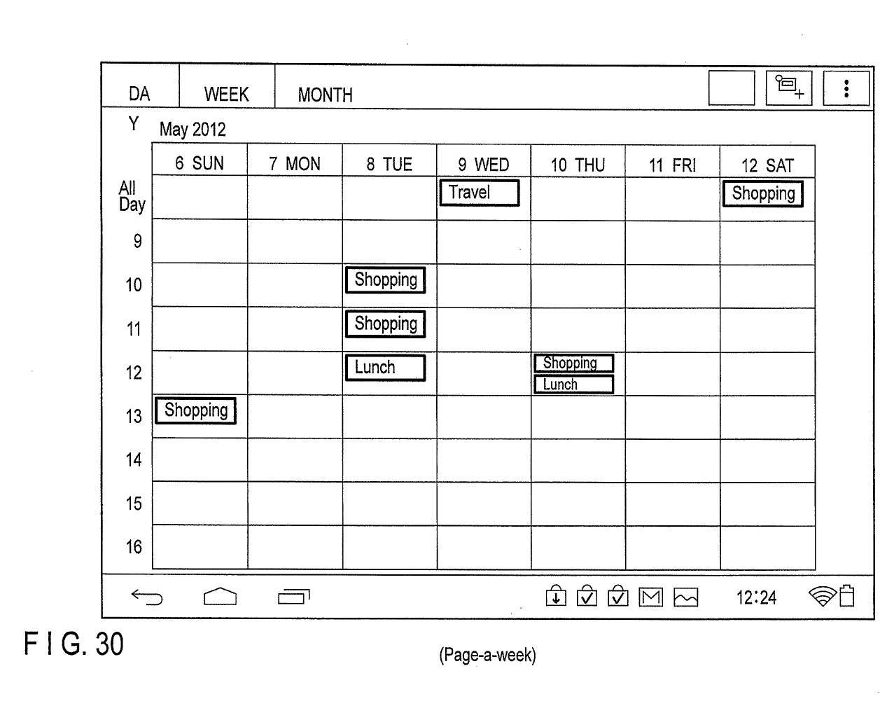

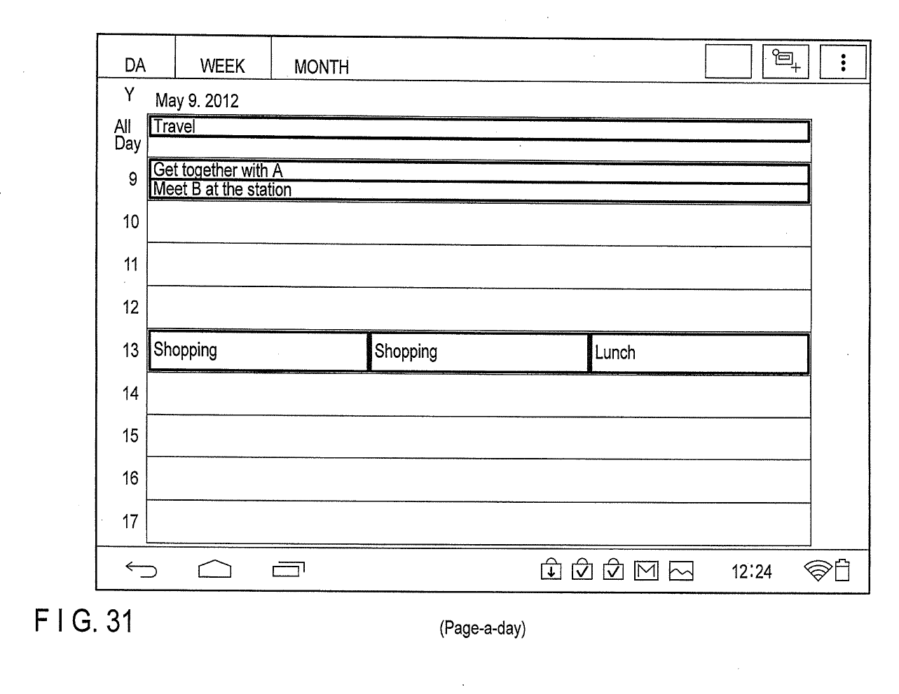

Therefore, the calendar display, month view, and list view modes can be obtained on a tablet screen. The display screen of the tablet has a high resolution. Accordingly, images as shown in FIGS. 29, 30, and 31 can be obtained on the tablet screen. FIG. 29 shows an image of a page-a-month calendar displayed on the screen of the tablet. FIG. 30 shows an image of a page-a-week calendar displayed on the screen of the tablet. FIG. 31 shows an image of a page-a-day calendar displayed on the screen of the tablet.

As seen from these examples, event icons, including a recording reservation, a viewing reservation, and an activity schedule, are displayed in the page-a-month calendar on the display screen of the TV apparatus. However, on the tablet, event names are displayed. The apparatus is not limited to the above embodiments.

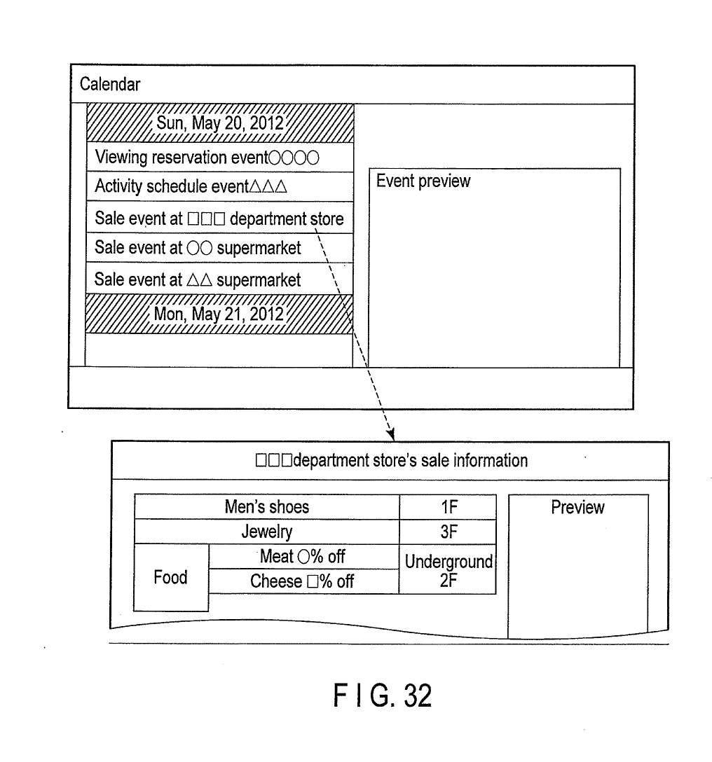

FIG. 32 shows another example of an image obtained by the information calendar processing system of the apparatus. FIG. 32 shows a case where, for example, the area of May 20 has been selected from a page-a-month calendar and various events of the day have been displayed. Suppose a sales event at a department store has been selected with the cursor and the acknowledge button has been pressed. Then, the contents of the sales at the department store are displayed in detail. Using such information, the user can cancel an activity schedule (such as shopping) on May 20, make a new determination, or change the schedule. Although a supermarket's schedule, a department store's schedule, and the like have been shown, a theater's special events schedule information, a movie theater's showing schedule information, and a famous star's open information may be taken in.

With the apparatus, when a recording reservation has been executed on the basis of recording reservation information, the recording reservation information is converted into recording history information. In addition, when viewing was actually performed at and on a viewing reservation time and date, viewing reservation information is converted into viewing history information, which is then stored. The aforementioned information processing is performed at the information calendar processing module shown in FIG. 25.

In the above explanation, even when a claim has been expressed by dividing a structural element of the claim into subelements, by putting some of the subelements together, or by combining the subelements, it is still in the scope of the invention. Furthermore, even when a claim is expressed as a method, the method is equivalent to the application of an apparatus of the invention. Moreover, the name of each part is not restrictive. Of course, it may be replaced with a module, a block, a unit, a circuit, means, a part, a device, logic, or the like.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a storage module configured to store first additional information related with a first calendar of the electronic device;
an acquisition module configured to acquire second additional information related with a second calendar of another electronic device;
a display controller configured to display, on a screen, the first additional information and the second additional information with the first calendar; and
a controller configured to perform processing corresponding to the second additional information if an operation on the second additional information displayed on the screen is performed.

2. The electronic device of claim 1, wherein the second additional information is related with an event, and
the controller is configured to output at least part of the second additional information to the display controller for displaying detailed information on the event if an operation on the second additional information displayed on the screen is performed.

3. The electronic device of claim 1, wherein the second additional information is related with either information of recording reservation or information of viewing reservation information, and
the controller is configured to output a recording instruction based on the information of recording reservation or output a viewing instruction based on the information of viewing reservation.

4. The electronic device of claim 1, wherein an account of the first calendar and an account of the second calendar are different.

5. The electronic device of claim 4, wherein the storage module is configured to store both the first additional information and the second additional information, and
the acquisition module is configured to acquire the second additional information from the storage module.

6. The electronic device of claim 4, wherein the acquisition module is configured to acquire the second additional information from another electronic device via a wireless communication channel.

7. The electronic device of claim 4, wherein the acquisition module acquires the second additional information of the second calendar from an external server.

8. The electronic device of claim 1, wherein the display controller configured to display the first calendar on a monthly basis and display an icon for the second additional information on a “day” in a “day” block, with the first calendar being displayed on a monthly basis.

9. The electronic device of claim 8, wherein the display controller is configured to display a list of event items in a “day” block of the first calendar.

10. The electronic device of claim 9, wherein the event items are plural and, when an event “day” includes different items,
the display controller is configured to separate the items with daily separators and display the resulting items.

11. The electronic device of claim 1, wherein the display controller is configured to switch to a display of an event list for a specific day when there has been an operation input, with the specific day of the first calendar on a monthly basis being specified.

12. A calendar information processing method comprising:
storing first additional information related to a first calendar of a first device;
acquiring second additional information related to a second calendar of a second device;
correlating the first additional information and the second additional information with the first calendar and outputting the resulting information; and
performing processing based on a operation on the second additional information of the first calendar.

13. The calendar information processing method of claim 12, wherein the second additional information is related with an event, and further comprising;
outputting at least part of the second additional information for displaying detailed information on the event if an operation on the second additional information displayed on a screen is performed.

14. The calendar information processing method of claim 12, wherein the second additional information is related with either information of recording reservation or information of viewing reservation information, and further comprising;
outputting a recording instruction based on the information of recording reservation or outputting a viewing instruction based on the information of viewing reservation.

15. The calendar information processing method of claim 12, wherein an account of the first calendar and an account of the second calendar are different.

16. The calendar information processing method of claim 15, further comprising;
storing both the first additional information and the second additional information, and
acquiring the second additional information from a storage module.

17. The calendar information processing method of claim 15, further comprising;
acquiring the second additional information from another electronic device via a wireless communication channel.

18. The calendar information processing method of claim 15, further comprising;
acquiring the second additional information of the second calendar from an external server.

19. The calendar information processing method of claim 12, further comprising;
displaying the first calendar on a monthly basis and displaying an icon for the second additional information on a “day” in a “day” block, with the first calendar being displayed on a monthly basis.

20. The calendar information processing method of claim 19, further comprising;
displaying a list of event items in a “day” block of the first calendar.

21. The calendar information processing method of claim 20, wherein the event items are plural and, when an event “day” includes different items, further comprising;
separating the items with daily separators and displaying the resulting items.

22. The calendar information processing method of claim 13, further comprising;
switching to a display of an event list for a specific day when there has been an operation input, with the specific day of the first calendar on a monthly basis being specified.

23. An information recording medium which stores a program that controls a computer, the program including
a command to store first additional information related to a first calendar of a first device;
a command to acquire second additional information related to a second calendar of a second device;
a command to relate the first additional information and the second additional information with the first calendar and output the resulting information; and
a command to perform processing based on a operation on the second additional information of the first calendar.

24. The information recording medium of claim 22, wherein the second additional information is related with an event, and
the program further including
a command to output at least part of the second additional information for displaying detailed information on the event if an operation on the second additional information displayed on a screen is performed.

25. The information recording medium of claim 22, wherein the second additional information is related with either information of recording reservation or information of viewing reservation information, and
the program further including
a command to output a recording instruction based on the information of recording reservation or output a viewing instruction based on the information of viewing reservation.

26. The information recording medium of claim 22, wherein an account of the first calendar and an account of the second calendar are different.

27. The information recording medium of claim 26,
the program further including
a command to store both the first additional information and the second additional information, and
a command to acquire the second additional information from a storage module.

28. The information recording medium of claim 26,
the program further including
a command to acquire the second additional information from another electronic device via a wireless communication channel.

29. The information recording medium of claim 26,
the program further including
a command to acquire the second additional information of the second calendar from an external server.

30. The information recording medium of claim 23,
the program further including
a command to display the first calendar on a monthly basis and display an icon for the second additional information on a “day” in a “day” block, with the first calendar being displayed on a monthly basis.

31. The information recording medium of claim 30,
the program further including
a command to display a list of event items in a “day” block of the first calendar.

32. The information recording medium of claim 31, wherein the event items are plural and, when an event “day” includes different items,
the program further including
a command to separate the items with daily separators and display the resulting items.

33. The information recording medium of claim 23,
the program further including
a command to switch to a display of an event list for a specific day when there has been an operation input, with the specific day of the first calendar on a monthly basis being specified.
